(19) United States
(12) Patent Application Publication
(10) Pub. No.: US 2024/0134709 A1
(43) Pub. Date: Apr. 25, 2024

(54) METHOD AND DEVICE FOR OPERATING A COMPUTING UNIT

(71) Applicant: Robert Bosch GmbH, Stuttgart (DE)

(72) Inventors: Benedikt Arthur Maximilian Mansbart, Stuttgart (DE); Manuel Jauss, Wissgoldingen (DE); Razvan Florin Aguridan, Leonberg (DE); Roland Steffen, Heimsheim (DE)

(21) Appl. No.: 17/768,273

(22) PCT Filed: Oct. 13, 2020
(86) PCT No.: PCT/EP2020/078884

§ 371 Date: Apr. 11, 2022

(30) Foreign Application Priority Data
Oct. 24, 2019 (DE) 10 2019 216 462.5

(51) Int. Cl. G06F 9/50; G06F 9/54; G06F 21/74

(52) U.S. Cl. CPC G06F 9/5061; G06F 9/544; G06F 21/74

(57) ABSTRACT

A method for operating a computing unit including at least one processor core. The method includes: assigning one or multiple application programs executable by the computing unit to one of at least two zones, the zones characterizing resources of the computing unit, which are usable for an execution of a relevant application program, executing at least one of the application programs as a function of the zone to which it is assigned.

### FIELD

The present invention relates to a method for operating a computing unit including at least one processor core.

The present invention further relates to a device for carrying out such a method.

### SUMMARY

Preferred specific example embodiments of the present invention relate to a method for operating a computing unit including at least one processor core, in particular, for an embedded system and/or for a control unit, in particular, for a vehicle, in particular, for a motor vehicle, the method including the following steps: assigning one or multiple application programs executable by the computing unit to one of at least two zones, the zones characterizing resources of the computing unit, which are usable for executing a relevant application program, executing at least one of the application programs as a function of the zone to which it is assigned. This advantageously allows for an increase in the security of the operation of the computing unit without adversely affecting the operational flexibility during the execution of the application program.

The method according to the specific example embodiments of the present invention is particularly preferably designed as a computer-implemented method.

In further preferred specific embodiments of the present invention, two zones or also more than two zones may be provided.

In further preferred specific embodiments of the present invention, the resources of the computing unit, which are characterizable by the zones, include at least one of the following elements: a) memory, b) execution time or computing time, the resources including, in particular, memory.

In further preferred specific embodiments of the present invention, it is provided that the computing unit includes multiple processor cores, the method further including: a) assigning at least one processor core to exactly one zone, and/or b) assigning at least one processor core to more than one zone, in particular, to two zones.

In further preferred specific embodiments of the present invention, it is provided that the method further includes: controlling, in particular limiting, at least one of the following elements: a) read rights to memory assigned to the computing unit, b) write rights to memory assigned to the computing unit, c) execution rights to memory assigned to the computing unit, as a function of the at least one zone.

In further preferred specific embodiments of the present invention, it is provided that the method further includes: using at least temporarily at least one memory protection unit for controlling the read rights and/or the write rights and/or the execution rights.

In further preferred specific embodiments of the present invention, it is provided that the method further includes: providing at least one dedicated memory protection unit for at least one processor core, one dedicated memory protection unit being in each case provided, in particular, for multiple, preferably for all processor cores.

In further preferred specific embodiments of the present invention, it is provided that the method further includes: providing a, in particular shared, memory protection unit for multiple processor cores.

In further preferred specific embodiments of the present invention, it is provided that at least one processor core assumes at least temporarily a first operating mode, in particular, the at least one processor core in the first operating mode specifying and/or writing configuration data, which control an operation of at least one memory protection unit, in particular, the at least one processor core assuming at least temporarily a second operating mode, in which it is unable to write and/or to change the configuration data for the at least one memory protection unit.

In further preferred specific embodiments of the present invention, it is provided that the at least one processor core assumes the first operating mode in an event-controlled manner, in particular, as a function of at least one interrupt request.

In further preferred specific embodiments of the present invention, it is provided that the method further includes: providing multiple sets of configuration data for the at least one memory protection unit, in particular, at least one first set of the multiple sets of configuration data being assigned to a first zone of the at least two zones and at least one second set of the multiple sets of configuration data being assigned to a second zone of the at least two zones.

In further preferred specific embodiments of the present invention, it is provided that the method further includes: providing one first instance of the application program and one second instance of the application program, assigning the first instance of the application program to a first zone of the at least two zones, assigning the second instance of the application program to a second zone of the at least two zones.

In further preferred specific embodiments of the present invention, it is provided that the method further includes: separating areas of a memory assigned to the computing unit as a function of the at least two zones, the memory assigned to the computing unit including at least one of the following elements: a) buffer memory, in particular, in the form of a working memory, b) stack memory, c) data memory, d) program memory, e) register memory, f) OTP (one-time programmable) memory, at least one memory protection unit being used for the separation.

In further preferred specific embodiments of the present invention, it is provided that the method further includes: exchanging first data between various zones via a buffer memory, in particular, a working memory, the exchange of the first data between the first zone and the second zone including, in particular, the following steps: copying the first data into a first buffer memory area assigned to the first zone, checking the copied first data and, in particular, as a function of the check, copying the first data from the first buffer memory area assigned to the first zone into a second buffer memory area assigned to the second zone.

In further preferred specific embodiments of the present invention, it is provided that the method further includes: separating computing time resources for different application programs and/or instances of application programs, in particular, assigning computing time resources for different application programs and/or for instances of application programs, as a function of the at least two zones.

In further preferred specific embodiments of the present invention, it is provided that the method further includes: a) using an operating system for embedded systems, in particular, a lightweight embedded operating system, for assigning computer time resources for different application programs and/or for instances of application programs, in particular, one processor core each of the computing unit being assigned an operating system, and/or b) using a supervisor for embedded systems, in particular, a lightweight embedded supervisor, for assigning computing time resources for different application programs and/or for instances of application programs, in particular, if the (instances of) application programs are assigned to different zones, in particular, one supervisor being assigned to one processor core each of the computing unit.

In further preferred specific embodiments of the present invention, it is provided that the operating system and/or the supervisor execute/executes an assignment of computer time resources, preferably only, for defined tasks, in particular, using a static task list.

In further preferred specific embodiments of the present invention, it is provided that the operating system and/or the supervisor execute/executes an assignment of computing resource times as a function of a) repeated, in particular, periodically repeated interrupt requests and/or b) event-controlled interrupt requests, in particular, tasks from at least one interrupt routine being activated.

In further preferred specific embodiments of the present invention, it is provided that upon entry into an interrupt routine, configuration data for at least one memory protection unit or for the at least one memory protection unit are changed, in particular, in a hardware-controlled manner.

In further preferred specific embodiments of the present invention, it is provided that the method further includes: monitoring, in particular, with the aid of the operating system and/or of the supervisor, at least one of the following elements, in particular, for a potential compromise: a) first zone, b) an application program assigned to the first zone c) an instance of an application program assigned to the first zone, the monitoring including, in particular: evaluating a stack memory and/or evaluating a program counter, the evaluation of a stack memory and/or evaluation of a program counter preferably taking place prior to an activation of the application program and/or of the instance of the application program. In further preferred specific embodiments, a monitoring routine of the supervisor is executed or carried out in a trustworthy operating mode (for example, a “supervisor mode”), in particular, by a trustworthy instance.

In further preferred specific embodiments of the present invention, it is provided that the method further includes: initiating an error response, in particular, when the monitoring suggests a potential compromise, the error response including at least one of the following elements: a) transferring the first zone and/or the processor core assigned to the first zone into a secure state, in particular, by deactivating the processor core assigned to the first zone and/or by resetting (executing a reset) the processor core assigned to the first zone and/or transferring into an error mode, b) generating an error entry and/or c) forwarding a or the error entry to an attack detection system, in particular, to an intrusion detection system (IDS). In further preferred specific embodiments, the IDS may, for example, be situated internally or externally with respect to the computing unit.

In further preferred specific embodiments of the present invention, cf. FIG. 2N, it is provided that the computing unit executes at least temporarily a cold start, data and/or program code being loaded, in particular, during the cold start from a non-volatile memory, and the computing unit executing at least temporarily a warm start, data and/or program code being loaded, in particular, during the warm start, from an at least temporarily energized, volatile memory, at least one memory protection unit being configured, in particular, during the cold start and/or the at least one memory protection unit being configured, in particular, during the warm start.

In further preferred specific embodiments of the present invention, it is provided that only that processor core to which a dedicated memory protection unit has been provided configures this dedicated memory protection unit.

In further preferred specific embodiments of the present invention, it is provided that the method further includes: checking an integrity and/or authenticity of configuration data, which control an operation of at least one memory protection unit, or the configuration data, in particular, with the aid of at least one of the following elements: a) verification of a program code useable for the configuration of the at least one memory protection unit, b) verification of the configuration data, c) persistence of a or of the program code useable for the configuration of the at least one memory protection unit, d) persistence of the configuration data.

In further preferred specific embodiments of the present invention, it is provided that the method further includes: carrying out at least temporarily a secure boot method and/or carrying out at least temporarily a method for manipulation detection during the runtime, in particular by at least one processor core.

In further preferred specific embodiments of the present invention, it is provided that the method further includes: controlling an access of an application program to at least one of the following elements as a function of at least one zone: a) internal interface, in particular, software interface, of the computing unit, b) internal and/or external hardware interface of the computing unit, c) hardware security module and/or cryptography module for carrying out cryptographic functions, d) peripheral devices of the computing unit, in particular, special function registers of at least one peripheral device, e) internal interfaces of a target system for the computing unit, in particular, of a control unit, f) external interfaces of a target system for the computing unit, in particular, of a control unit g) addressing elements for communication protocols, in particular, on at least one layer of the ISO/OSI layer model.

In further preferred specific embodiments of the present invention, it is provided that the method further includes at least one of the following elements: a) introducing at least one additional, in particular not previously existing, zone, b) shifting functionalities from one first processor core to at least one further processor core of the computing unit, c) carrying out a communication between at least two zones using a, in particular, working memory integrated, in particular, into the computing unit, d) defining at least one trustworthy zone and, optionally, monitoring at least one further, in particular, non-trustworthy, zone by at least one application program assigned to the trustworthy zone. In further preferred specific embodiments, the monitoring of the at least one further, in particular, non-trustworthy, zone may be carried out, for example, by a program, for example, an interrupt service routine (ISR), preferably in a monitoring mode, which may also be referred to as “supervisor mode.”

Further preferred specific embodiments of the present invention relate to a device for carrying out the method according to the specific embodiments.

In further preferred specific embodiments of the present invention, it is provided that the device includes at least one of the following elements: a) a computing unit including at least one processor core, b) a memory unit, c) a data bus, d) a memory protection unit, e) a hardware security module.

In further preferred specific embodiments of the present invention, it is provided that the device is designed as a microcontroller, in particular, as a single microcontroller or as a system-on-chip (SoC), in particular, as a single SoC.

In further preferred specific embodiments, it is provided that the device includes an, in particular, shared, semiconductor substrate, at least one of the following elements being situated on the, in particular, shared, semiconductor substrate: a) the computing unit including at least one processor core, b) the memory unit, c) the data bus, d) the memory protection unit, e) the hardware security module.

Further preferred specific embodiments of the present invention relate to a computer-readable memory medium, including commands, in particular, in the form of a computer program which, when executed by a computer, prompt the computer to carry out the method according to the specific embodiments.

Further preferred specific embodiments of the present invention relate to a computer program, including commands which, upon execution of the program by a computer, prompt the computer to carry out the method according to the specific embodiments.

Further preferred specific embodiments of the present invention relate to a data carrier signal, which transfers the computer program according to the specific embodiments.

Further preferred specific embodiments of the present invention relate to a use of the method according to the specific embodiments and/or of the device according to the specific embodiments and/or of the computer program according to the specific embodiments for at least one of the following elements: a) providing trust boundaries in the computing unit, in particular, also within a processor core of the computing unit, b) reducing an attack surface for attacks on the computing unit and/or on one of its components, c) limiting access rights to memories, d) limiting access rights to peripherals, e) limiting access rights to computing resources, f) minimizing an influence of a corrupted component, g) operating a control unit, in particular, for a vehicle, in particular, for a motor vehicle, h) operating an embedded system, in particular, an Internet of Things (IoT) system, i) operating an application-specific integrated circuit, ASIC, j) detecting a corrupted zone, k) initiating an error response, in particular, in the event of a detected compromise.

In further preferred specific embodiments of the present invention, the method and/or the device according to the specific embodiments may be used in a control unit, for example, in a control unit for a motor vehicle, in particular, in a control unit for an internal combustion engine of a motor vehicle, for example, for at least one of the following particular applications: a) controlling an operation or an operating state transition of the control unit, b) unblocking or blocking one or multiple functions of the control unit and/or of another component and/or for example, of the motor vehicle, c) switching into an error mode and/or emergency mode, d) carrying out an error memory entry, e) signaling an operating state to an external unit and/or to a user, f) activating an actuator.

Further preferred specific embodiments of the present invention relate to a use of the method according to the specific embodiments and/or of the device according to the specific embodiments and/or of the computer program according to the specific embodiments for checking at least one subarea of the memory unit for changes or manipulations, in particular, prior to or during or after a switch of the memory unit and/or of a computing unit accessing the memory unit, from a first operating state into a second operating state, and for controlling an operation, for example, a control unit of an internal combustion engine of a motor vehicle as a function of the check.

### BRIEF DESCRIPTION OF THE DRAWINGS

Further features, applications and advantages of the present invention result from the following description of exemplary embodiments of the present invention, which are represented in the figures. All features described or represented form the subject matter of the present invention or in arbitrary combination, regardless of their wording or representation in the description or in the figures.

FIG. 1 schematically shows a simplified block diagram of a computing unit according to preferred specific embodiments of the present invention.

FIG. 2A schematically shows a simplified flowchart of a method according to further preferred specific embodiments of the present invention.

FIG. 2B through 2U each schematically shows a simplified flowchart of a method according to further preferred specific embodiments of the present invention.

FIG. 3 schematically shows a simplified block diagram of a computing unit according to further preferred specific embodiments of the present invention.

FIGS. 4, 5 each schematically shows a simplified block diagram of aspects according to further preferred specific embodiments of the present invention.

FIGS. 6, 7 each schematically shows aspects of interrupt service routines according to further preferred specific embodiments of the present invention.

FIG. 8 schematically shows a flowchart according to further preferred specific embodiments of the present invention.

FIG. 9 shows aspects of interrupt service routines according to further preferred specific embodiments of the present invention.

FIGS. 10, 11 each schematically shows a simplified block diagram of aspects according to further preferred specific embodiments of the present invention.

FIGS. 12A, 12B each schematically shows aspects of interrupt service routines according to further preferred specific embodiments of the present invention.

FIG. 13 schematically shows a simplified block diagram of aspects according to further preferred specific embodiments of the present invention.

FIG. 14 schematically shows a flowchart according to further preferred specific embodiments,

FIGS. 15 through 19 each schematically shows a simplified block diagram of aspects according to further preferred specific embodiments of the present invention.

FIGS. 20, 21 each schematically shows a flowchart according to further preferred specific embodiments of the present invention.

FIG. 22 schematically shows a simplified block diagram of a device according to further preferred specific embodiments of the present invention.

FIG. 23 schematically shows a simplified block diagram of configuration data according to further preferred specific embodiments of the present invention.

### DETAILED DESCRIPTION OF EXAMPLE EMBODIMENTS

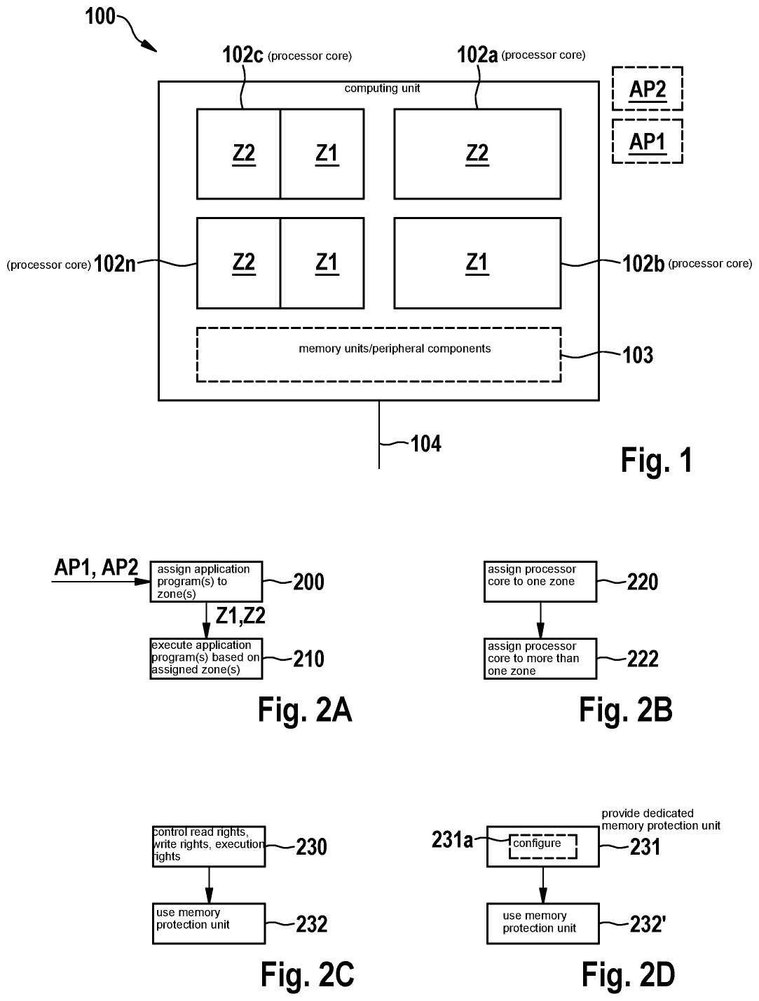

FIG. 1 schematically shows a simplified block diagram of a computing unit 100 according to preferred specific example embodiments of the present invention. Computing unit 100 includes at least one processor core, in the present case, for example, four processor cores 102a, 102b, 102c, 102n, and may be used, in particular, for example, for an embedded system and/or for a control unit, in particular, for a vehicle, in particular, for a motor vehicle.

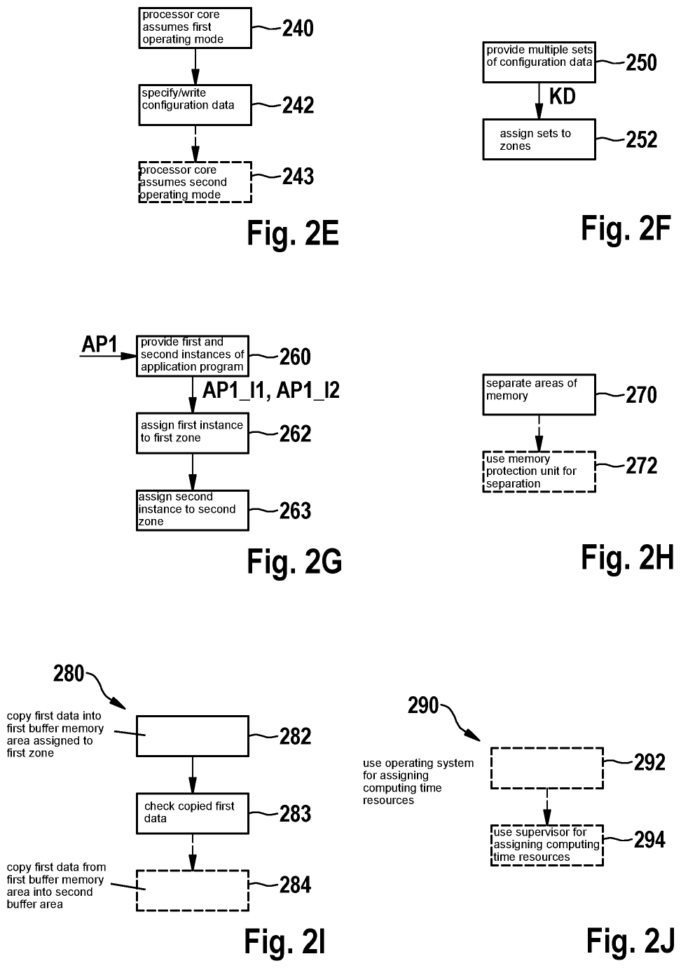

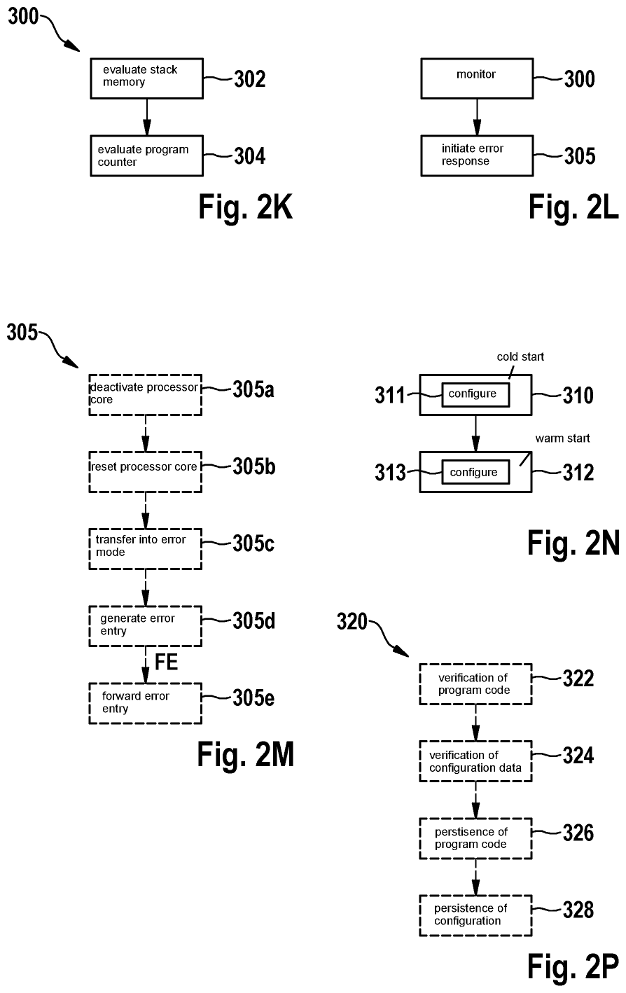

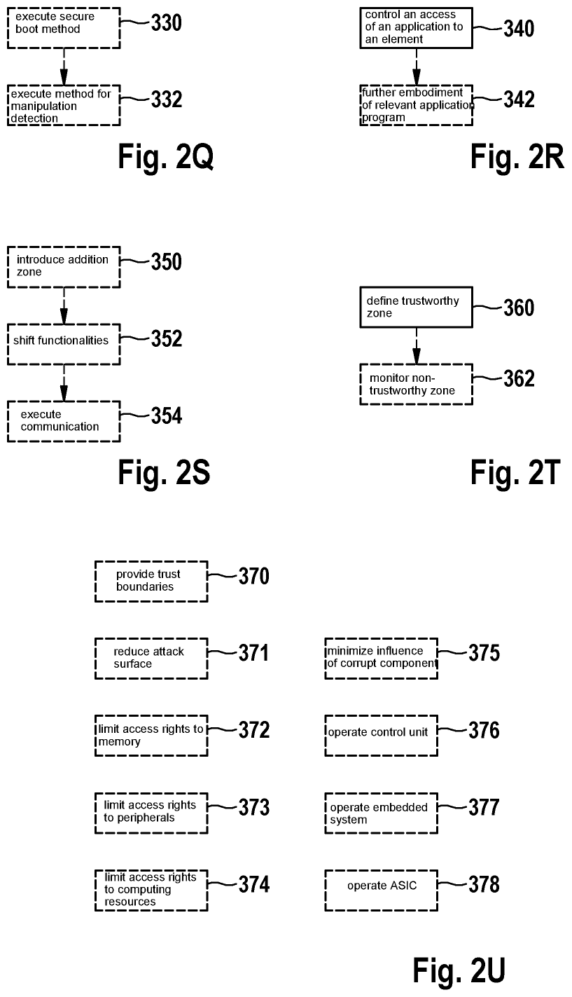

Preferred specific embodiments relate to a method for operating computing unit 100, which includes the following steps, cf. the flowchart of FIG. 2A: assigning 200 one or multiple application programs AP1, AP2 executable by computing unit 100 (FIG. 1) to one of at least two zones Z1, Z2, zones Z1, Z2 characterizing resources of computing unit 100, which are usable for an execution of a relevant application program AP1, AP2, executing 210 at least one of application programs AP1, AP2 as a function of zones Z1, Z2 to which it is assigned. This advantageously allows for an increase in the security of the operation of computing unit 100 without adversely affecting the operational flexibility during the execution of application programs AP1, AP2.

In further preferred specific embodiments, trust boundaries may be defined, for example, as a result, for example, between trustworthy and non-trustworthy instances/units/domains. In this way, for example, first application programs for the computing unit may be assigned to a non-trustworthy first zone (NTZ) and second application programs for the computing unit may be assigned to a trustworthy second zone (TZ).

In further preferred specific embodiments, it is provided that computing unit 100 (FIG. 1) includes multiple (for example, as depicted by way of example in FIG. 1, four) processor cores 102a, 102b, 102c 102n, the method further including, cf. FIG. 2B: a) assigning 220 at least one processor core to exactly one zone, and/or b) assigning 222 at least one processor core to more than one zone, in particular to two zones.

In further preferred specific embodiments, for example, first processor core 102a is assigned to a first zone Z1 which may, for example, represent a non-trustworthy zone, and second processor core 102b is assigned to a second zone Z2, which may, for example, represent a trustworthy zone.

In further preferred specific embodiments, third processor core 102c, for example, is assigned to both first zone Z1 as well as to second zone Z2, see FIG. 1. The same may similarly also apply in further specific embodiments to fourth processor core 102n of computing unit 100.

In further preferred specific embodiments, computing unit 100 according to FIG. 1 may also have further components not listed in detail in FIG. 1 such as, for example one or multiple memory units and/or peripheral components which, for the sake of clarity, are indicated in FIG. 1 together with the aid of dashed rectangle 103. Reference numeral 104 symbolizes one or multiple data interfaces.

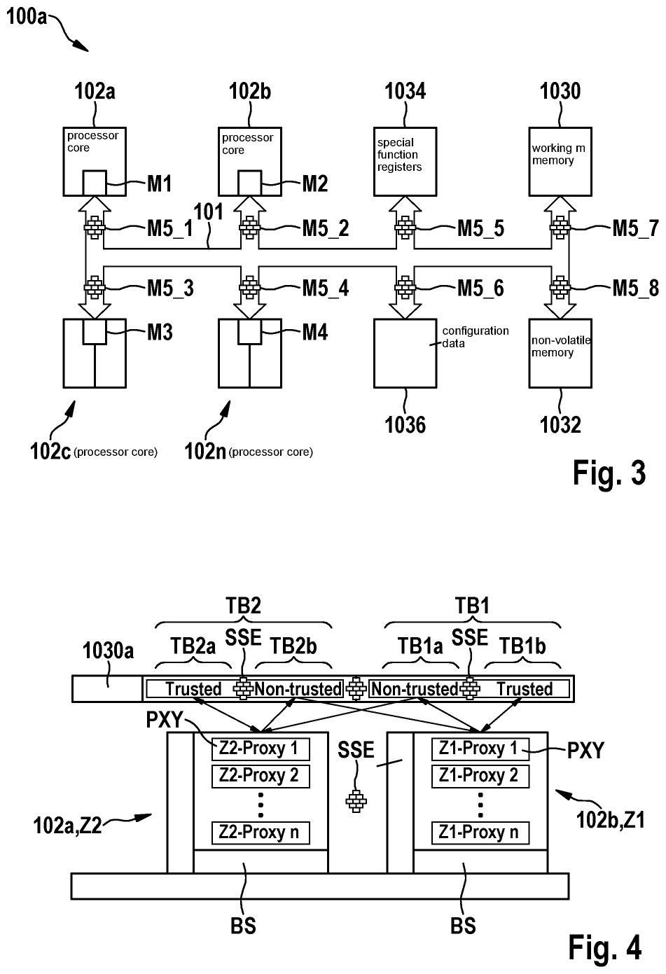

FIG. 3 schematically shows a simplified block diagram of a computing unit 100a according to further preferred specific embodiments which—similar to computing unit 100 according to FIG. 1—includes four processor cores 102a, 102b, 102c, 102n. FIG. 3 also shows a working memory (RAN) 1030, a non-volatile memory 1032 (for example, a flash memory, in particular, flash-EEPROM), and optionally present special function registers 1034 of computing unit 100a, as they are usable, for example, for controlling an operation of peripheral components thereof. Components 102a, 102b, . . . , 1034 among one another are connected to one another via a bus system 101.

In further preferred specific embodiments, it is provided that the method for operating computing unit 100 (FIG. 1), 100a (FIG. 3) further includes, cf. FIG. 2C: controlling 230, in particular, limiting at least one of the following elements: a) read rights to memory 1030, 1032 assigned to computing unit 100, 100a, b) write rights to memory 1030, 1032 assigned to the computing unit, c) execution rights to memory 1030, 1032 assigned to the computing unit as a function of at least one zone Z1, Z2. This advantageously ensures that only those application programs AP1, AP2 (FIG. 1) obtain access to the cited memory or memories 1030, 1032, which are assigned to a corresponding zone Z1, Z2. In further preferred specific embodiments, for example, this may prevent an application program of a non-trustworthy zone from accessing the memory or memories 1030, 1032 (in particular, for example, access to memory area 1030, 1032 assigned to the trustworthy zone by the non-trustworthy zone), which potentially represents a risk with respect to a possible manipulation of the memory content by the application program of the non-trustworthy zone.

In further preferred specific embodiments, it is provided that the method further includes, cf. FIG. 2C: using 232 at least temporarily at least one memory protection unit M1, M2, M3, M4, M5_1, M5_2, M5_3, M5_4, M5_5, M5_6, M5_7, M5_8 (FIG. 3) for controlling the read rights and/or write rights and/or the execution rights.

In further preferred specific embodiments, it is provided that the method further includes, cf. FIG. 2D: providing 231 at least one dedicated memory protection unit M1 for at least one processor core 102a, one dedicated memory protection unit M1, M2, M3, M4 being in each case provided, in particular, for multiple, preferably for all, processor cores 102a, 102b, 102c, 102n. In further preferred specific embodiments, respective (dedicated) memory protection unit M1, M2, M3, M4 may then be used, cf. step 232′ from FIG. 2D in order, in particular, to carry out the aforementioned controlling 230, in particular, limiting of the aforementioned access rights, in particular, read rights and/or write rights and/or the execution rights.

In further preferred specific embodiments, use 232′ (FIG. 2D) may precede an optional configuration 231a of the memory protection unit(s).

In further preferred specific embodiments, cf. FIG. 2E, it is provided that at least one processor core 102a assumes at least temporarily a first operating mode, cf. step 240, in particular, the at least one processor core 102a in the first operating mode specifying and/or writing 242 configuration data 1036 (FIG. 3), which control an operation of at least one memory protection unit M1, M2, . . . , M5_8, in particular, the at least one processor core 102a assuming 243 at least temporarily a second operating mode, in which it is unable to write and/or to change the configuration data for the at least one memory protection unit M1, M2, . . . , M5_8.

In further preferred specific embodiments, the first operating mode may also be referred to as “supervisor mode.” The “supervisor mode” may thus preferably represent a privileged state, in which the relevant processor core 102a is able to carry out a configuration of the at least one memory protection unit M1, M2, . . . , M5_8.

In further preferred specific embodiments, the configuration data for the at least one memory protection unit M1, M2, . . . M5_8 may be provided, for example, in the form of special function registers (SFR), in particular, configuration registers 1036, which are potentially also at least temporarily accessible via bus system 101, preferably by controlling a corresponding memory protection unit M5_6. In other words, in further preferred specific embodiments, special function registers (SFR), in particular, configuration register 1036, may be provided, for example, for the configuration data of the at least one memory protection unit M1, M2, . . . , M5_8.

In further preferred specific embodiments, it is provided, cf. FIG. 2E, that the at least one processor core 102a assumes 240 the first operating mode in an event-controlled manner, in particular, as a function of at least one interrupt request.

In further preferred specific embodiments, it is provided that the method further includes, cf. FIG. 2F: providing 250 multiple sets of configuration data KD for the at least one memory protection unit M1, M2, . . . , M5_8, in particular, at least one first set of the multiple sets of configuration data KD being assigned to a first zone Z1 of the at least two zones and at least one second set of the multiple sets of configuration data KD being assigned to a second zone Z2 of the at least two zones, cf. step 252.

In further preferred specific embodiments, it is provided that at least one processor core 102a assumes a particular operating mode such as, for example, the supervisor mode within the scope of dedicated system states, for example, in a start cycle and/or during particular events, for example when entering into an interrupt service routine (ISR), which may take place, for example, in a hardware-controlled manner.

In further preferred specific embodiments, at least one further non-privileged operating mode is provided for one or for multiple, preferably for all processor cores (“non-privileged mode”), which in further preferred specific embodiments may also be referred to as “user mode.” In the user mode, configuration data KD, 1036 are preferably not writable for the at least one memory protection unit M1, M2, . . . , M5_8. In other words, in further preferred specific embodiments, a processor core that is currently in the user mode, is unable to write or to change configuration data KD, 1036 for the at least one memory protection unit M1, M2, . . . , M5_8, whereas a processor core that is presently in the supervisor mode is able to write or to change configuration data KD, 1036 for the at least one memory protection unit M1, M2, . . . , M5_8.

In further preferred specific embodiments, it is provided that application programs AP1, AP2 are executed in a non-privileged mode, for example, in the user mode.

In further preferred specific embodiments, three operating modes or operating states or modes, for example, may be provided, for example: first a supervisor mode, second a “user mode 1,” in particular for non-trustworthy zone(s), third, a “user mode 2,” in particular, for trustworthy zone(s).

In further preferred specific embodiments, static configuration data KD2 may be active, for example, in user mode 1 and, for example, a first application program AP1 runs.

In further preferred specific embodiments, static configuration data KD3 may be active, for example, in user mode 2 and, for example, a second program AP2 runs.

In further preferred specific embodiments, static configuration data KD1, for example, are active in the supervisor mode, the supervisor mode being used, for example, (optionally solely) for switching between static configuration data KD2 and static configuration data KD3.

In further preferred specific embodiments, user modes 1 and 2 are unable to switch between static configuration data KD1, KD2, KD3, KD4.

In further preferred specific embodiments, (only) two modes (for example, supervisor mode and user mode) may, for example, also be provided. Accordingly, in further preferred specific embodiments, for example, the supervisor mode may be assigned to the trustworthy mode and, for example may carry out the switch between configuration data KD1 and configuration data KD2, as well as, if necessary, executing second application program AP2, for example.

In further preferred specific embodiments, for different operating modes or operating states (for example, privileged and non-privileged mode or supervisor mode, user mode), specific read rights and/or write rights and/or execution rights, for example, to memory or memories 1030, 1032 are granted for the respective operating mode, which is implementable in further preferred specific embodiments, for example, by providing different sets of configuration data KD (“configuration data sets”).

In further preferred specific embodiments, operating mode-specific and/or application-specific read rights and/or write rights and/or execution rights are granted for different combinations of operating mode(s) including respective application programs, which is implementable in further preferred specific embodiments, for example, also by providing different sets of configuration data KD (“configuration data sets”). Thus, for example, read rights and/or write rights and/or execution rights adapted in each case to the relevant application program AP1, AP2 may be granted, for example, for the user mode for different application programs AP1, AP2 (FIG. 1).

In further preferred specific embodiments, one or multiple, preferably all of memory protection units M1, M2, . . . , M5_8 mentioned by way of example include multiple configuration data sets which, in further preferred specific embodiments, may be preferably efficiently assigned to different modes and application programs AP1, AP2.

In further preferred specific embodiments, a switch may be efficiently made, in particular, in a hardware-controlled manner, between the configuration data sets for the relevant modes or operating modes, for example, during a change between privileged or non-privileged modes (for example, a change from supervisor mode to user mode or vice versa) or between application programs, in particular, in a non-privileged mode.

In further preferred specific embodiments, computing unit 100, 100a (FIG. 3) includes by way of example the following configuration possibilities mentioned by way of example: a) a, in particular, static (non-changeable), configuration data set for at least one central memory protection unit or at least one memory protection unit M5_1, . . . , M5_8 assigned to bus system 101 (FIG. 3), four, in particular, static configuration data sets each for dedicated memory protection units M1, M2, M3, M4, these four configuration data sets each for the dedicated memory protection units in further preferred specific embodiments including, for example, one static configuration data set for the supervisor mode and, for example, three static configuration data sets for application programs AP1, AP2, i.e., for example, for the user mode. FIG. 23 schematically shows exemplary configuration data sets KD′ including a total of four configuration data sets KD1, KD2, KD3, KD4.

In further preferred specific embodiments, the configuration data define, for example, which memory addresses a component of computing unit, for example, a processor core, may access in terms of reading and/or writing and/or executing. The memory protection unit in further preferred specific embodiments may be designed to compare accesses (reading and/or writing and/or executing) instantaneously executed by the relevant processor core with the content of the configuration data, and, for example, if they conform, to allow or prevent the relevant accesses or vice versa.

In further preferred specific embodiments, the aforementioned, preferably static, configuration data sets for the dedicated memory protection units M1, M2, M3, M4, for example for the user mode, may correlate with zones Z1, Z2 according to the specific embodiments.

In further preferred specific embodiments, in particular, in the case of a so-called “inter-core-zone-separation,” only application programs of a particular zone Z2 (for example, including the same trust level) are executed on a particular processor core 102a (FIG. 1). In further preferred specific embodiments, in particular, in the case of a dedicated memory protection unit M1 (FIG. 3) for such a processor core 102a, for example, only two, in particular, static, configuration data sets are used, for example, one for the supervisor mode and one for application programs in the user mode. Potentially remaining, previously unused configuration data sets for application programs, in particular, in the user mode, may be configured in further preferred specific embodiments, for example, in such a way that these configuration data sets inhibit a general read access, write access and execution access to complete memory 1030, 1032, as a result of which the security is further increased.

In further preferred specific embodiments, in particular, in the case of a so-called “intra-core-zone-separation,” application programs of two zones Z1, Z2, including, for example, two different trust levels each, are executed on a particular processor core 102c (FIG. 1). Two different static configuration data sets are preferably used here for the application programs of first zone Z1 and the application programs of second zone Z2, in particular, for the user mode, and preferably one further static configuration data set for one further operating mode, for example, the supervisor mode. In further preferred specific embodiments, processor core 102c is designed to take over a switch in the operating mode of the supervisor mode between the two static configuration data sets for the two zones Z1, Z2. In further preferred specific embodiments, processor core 102c may thus activate in the supervisor mode a configuration data set suitable for first zone Z1 in its dedicated memory protection unit if, for example, an application program AP1 assigned to first zone Z1 is to be executed, and may, for example, activate a configuration data set suitable for second zone Z2 in its dedicated memory protection unit if, for example, an application program AP2 assigned to second zone Z2 is to be executed. Potentially remaining, previously unused configuration data sets for application programs, in particular, in the user mode (in the present case a configuration data set, with the total number of 4 pieces mentioned by way of example), may be configured in further preferred specific embodiments in such a way, for example, that these configuration data sets inhibit a general read access, write access and execution assess to complete memory 1030 1032, as a result of which the security is further increased.

In further preferred specific embodiments, cf. FIG. 2G, it is provided that the method further includes: providing 260 one first instance AP1_I1 of application program AP1 and one second instance AP1_I2 of application program AP1, assigning 262 first instance AP1_I1 of application program AP1 to a first zone Z1 of the at least two zones, assigning 263 second instance AP1_I2 of application program AP1 to a second zone Z2 of the at least two zones. In this way, it is possible to advantageously cover particular applications, in which an application or an application program AP1 “extends” over multiple zones Z1, Z2. Thus, in further preferred specific embodiments, one instance AP1_I1, AP1_I2 per zone may exist for this application program AP1, such an instance also being able to be referred to in further preferred specific embodiments as a proxy.

In further preferred specific embodiments, such a proxy AP1_I2 for the relevant further zone Z2 is able to cover relevant (sub)functionalities. In further preferred specific embodiments, a proxy is also able, if necessary, to include multiple subcomponents.

In further preferred specific embodiments, computing unit 100, 100a may execute, for example, the following scenario: if a first application program AP1 is to receive data from a, for example, non-trustworthy first zone Z1—for example, remote service requests from the Internet—and to accordingly process or forward these data within trustworthy zone Z2—for example, for executing the corresponding service (“remote service”)—the reception of the data takes place within first zone Z1 by Z1 proxy AP1_I1 of application program AP1, the corresponding Z2 proxy AP1_I2, for example, carrying out the following steps: a data verification of the data classified by Z2 proxy AP1_I2, in particular, by default as non-trustworthy and—in the event of a successful data verification—the processing or forwarding of the data now classified (according to the data verification) as trustworthy within second zone Z2.

In further preferred specific embodiments, it is provided that the method further includes, cf. FIG. 2H: separating 270 areas of a memory 1030, 1032 assigned to computing unit 100, 100a as a function of the at least two zones Z1, Z2, the memory assigned to computing unit 100, 100a including at least one of the following elements: a) buffer memory, in particular, in the form of a working memory, b) stack memory, c) data memory, d) program memory, e) register memory, at least one memory protection unit being used for the separation 270, cf. optional step 272.

In further preferred specific embodiments, it is provided that the method further includes, cf. FIG. 2I: exchanging 280 first data between various zones via a buffer memory, in particular, a working memory, the exchange of the first data between first zone Z1 and second zone Z2 including the following steps: copying 282 the first data into a first buffer memory area assigned to the first zone, checking 283 the copied first data, and copying 284 the first data from the first buffer memory area assigned to first zone Z1 into a second buffer memory area assigned to second zone Z2, in particular, as a function of the check.

FIG. 4 schematically shows a simplified block diagram of aspects of computing unit 100, 100a according to further preferred specific embodiments. The two processor cores 102a, 102b are depicted which, as previously described above, are assigned to respective zones Z1, Z2. One area 1030a of working memory 1030 (FIG. 3) is usable in the present case as a buffer memory or “split working memory,” in particular, for exchanging data between various zones Z1, Z2 or between relevant processor cores 102a, 102b or between (instances of) application programs executable thereon, one first subarea TB1 being assigned to first zone Z1 or to second processor core 102b and one second subarea TB2 being assigned to second zone Z2 or first processor core 102a.

Multiple proxies PXY are also depicted in FIG. 4, for example, a first number of proxies Z1-proxy 1, Z1-proxy 2, . . . , Z1-proxy n being assigned to first zone Z1, i.e., in the present case, to processor core 102b, and a second number of proxies Z2-proxy 1, Z2-proxy 2, . . . , Z2-proxy n being assigned to second zone Z2, i.e., in the present case, to processor core 102a. In the present case, multiple memory protection units or functional components thereof are identified with reference sign SSE, which in FIG. 4 symbolically indicate a corresponding separation of subareas TB1, TB2 or of zones Z1, Z2 from one another or among one another corresponding to the principle according to preferred specific embodiments.

In further preferred specific embodiments, at least one of subareas TB1, TB2 may in turn be subdivided into different areas TB1a, TB1b or TB2a, TB2b, area TB1a, for example, corresponding to a non-trustworthy area of first subarea TB1, area TB1b corresponding to a trustworthy area of first subarea TB1 area TB2a corresponding to a trustworthy area of second subarea TB2 and area TB2b corresponding to a non-trustworthy area of second subarea TB2. In further preferred specific embodiments, a separation of subareas TB1, TB2 or of different areas TB1a, TB1b or TB2a, TB2b may be provided with the aid of at least one memory protection unit.

In further preferred specific embodiments, cf. FIG. 2J, it is provided that the method further includes: separating 290 computing time resources for different application programs AP1, AP2 and/or instances of application programs, in particular, assigning computing time resources for different application programs and/or for instances of application programs, as a function of the at least two zones Z1, Z2.

In further preferred specific embodiments, it is provided that the method further includes: using 292 an operating system BS for embedded systems, in particular, a lightweight embedded operating system BS, for assigning computing time resources for different application programs AP1, AP2 and/or for instances AP1_I1, AP2_I2 of application programs, in particular, one processor core each of computing unit 100, 100a being assigned an operating system BS, see FIG. 4.

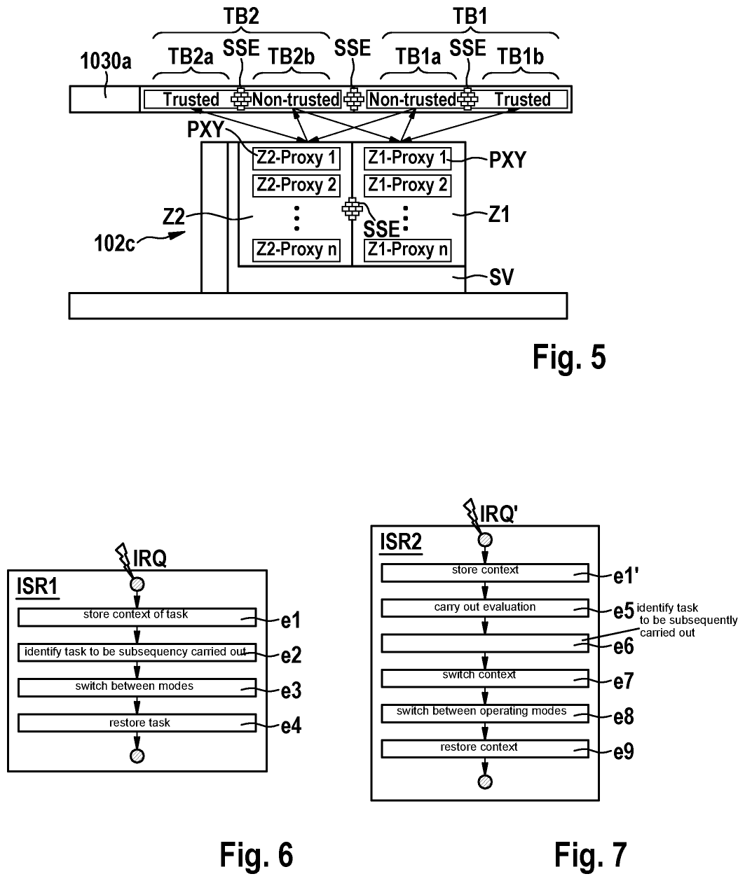

In further preferred specific embodiments, it is provided that the method alternatively or in addition to step 292 according to FIG. 2J further includes: using 294 a supervisor SV for embedded systems, cf. FIG. 5, in particular, a lightweight embedded supervisor SV, for assigning computing time resources for different application programs and/or for instances of application programs, in particular, one processor core 102c each (FIG. 5) of the computing unit being assigned a supervisor SV.

In further preferred specific embodiments, it is provided that operating system BS and/or supervisor SV executes or execute an assignment of computing time resources, preferably only, for predefined tasks (application programs and/or instances of application programs and/or parts thereof), in particular, using a static (non-changeable) task list. In other words, in further preferred specific embodiments, a scheduling of predefined tasks only is possible, which further increases the security.

In further preferred specific embodiments, it is provided that operating system BS (FIG. 4) and/or supervisor SV (FIG. 5) executes and/or execute an assignment of computing time resources as a function of a) repeated, in particular, periodically repeated, interrupt requests (for example, timer interrupts) and/or b) event-controlled interrupt requests, tasks being activated, in particular, from at least one interrupt service routine (ISR, a computer program, which is executed upon occurrence of an interrupt request).

In further preferred specific embodiments, it is provided that upon entering into an interrupt routine, configuration data for at least one memory protection unit M1, M2, . . . , SSE are changed, in particular, in a hardware-controlled manner.

In further preferred specific embodiments, lightweight embedded OS BS (FIG. 4) or lightweight embedded supervisor SV (FIG. 5), may coordinate and/or orchestrate (“scheduling”) cyclically or event-based executing (proxy)functionalities (tasks).

In further preferred specific embodiments, lightweight embedded OS BS and the lightweight embedded supervisor include, in particular, at least one of the following properties:
a) minimizing attack surfaces by reducing complexity (amount of code, functionality, flexibility, etc.) to a necessary minimum,
b) scheduling of predefined tasks only (static task lists, no dynamic task lists possible), scheduling based, for example, on ISR with, for example, cyclical interrupt requests (IRQ), for example, timer IRQ and/or event-based IRQs—for example Rx (receive) IRQ, Tx (send) IRQ, SW (software) IRQ, etc. tasks are activated from ISR,
c) When entering in ISR, a hardware-controlled switch into the supervisor mode preferably takes place: for example, switch to static configuration data set for the supervisor mode, preferably a switch between static configuration data sets (for example for user modes) is possible only in supervisor mode,
d) a switch from the supervisor mode to the user mode preferably further takes place prior to the activation of a task, an execution of tasks, in particular, (for example, parts of (instances of) application programs) taking place in the user mode, further in particular, no switch between (static) configuration data sets in the user mode or in tasks being possible,
e) in further preferred specific embodiments, it is advantageously provided already implicitly by a static (and potentially in particular also integral and authentic) configuration of memory protection unit(s), for example, during a start cycle, that no dynamic reconfiguration of memory protection units is able to take place with the aid of an interrupt service routine (ISR) provided for the supervisor mode (for example, from lightweight embedded OS BS/supervisor SV).

In further preferred specific embodiments, it is provided that the method further includes, cf. FIG. 2K: monitoring 300, in particular, with the aid of operating system BS (FIG. 4) and/or of supervisor SV (FIG. 5), at least one of the following elements, in particular, for a potential compromise: a) first zone Z1, b) an application program AP1 assigned to first zone Z1, c) an instance AP1_I1 of an application program AP1 assigned to first zone Z1, monitoring 300 including, in particular: evaluating 302 (FIG. 2K) a stack memory (“stack”) and/or evaluating 304 a program counter (PC), evaluation 302 of stack memory and/or evaluation 304 of the program counter taking place preferably prior to an activation of the application program and/or of the instance of the application program.

In further preferred specific embodiments, it is provided that the method further includes, cf. FIG. 2L: monitoring 300, see above at FIG. 2K, and initiating 305 an error response, in particular, when monitoring 300 suggests a potential compromise.

In further preferred specific embodiments, it is provided that the error response or initiation 305 of the error response includes at least one of the following elements, cf. FIG. 2M: a) transferring first zone Z1 and/or processor core 102b (FIG. 1) assigned to first zone Z1 into a secure state, in particular, by deactivating 305a processor core 102b assigned to first zone Z1 and/or by resetting 305b processor core 102b assigned to first zone Z1 and/or transferring 305c into an error mode, b) generating 305d an error entry FE and/or c) forwarding 305e an or the error entry to an attack detection system, in particular, an intrusion detection system. In further preferred specific embodiments, the IDS may, for example, be situated internally and/or externally with respect to computing unit 100, 100a.

In further preferred specific embodiments, the IDS may, for example, also include a distributed implementation, first sub-functionalities (such as, for example, IDS sensors and, if necessary, an IDS master), for example, being implemented or carried out on a or on the computing unit or on at least one processor core of the computing unit and, in particular, other parts or further subfunctionality(ies) being implemented in another device, for example, in a backend. In further preferred specific embodiments, the backend may, for example, also be designed to implement at least one of the following aspects: a) in-depth expert analysis, b) artificial intelligence (KI), c) machine learning (ML), etc.

In further preferred specific embodiments, cf. FIG. 2N, it is provided that computing unit 100, 100a executes at least temporarily a cold start 310, during cold start 310, data and/or program code, in particular, being loaded from a non-volatile memory 1032 (FIG. 3), and computing unit 100, 100a executing at least temporarily a warm start 312 (FIG. 2N), during warm start 312, data and/or program code, in particular, being loaded from an at least temporarily energized volatile memory 1030 (FIG. 3), during cold start 310 (FIG. 2N), at least one memory protection unit or the at least one memory protection unit, in particular, being configured, cf. step 311 from FIG. 2N, and/or (also) during warm start 312, the at least one memory protection unit, in particular, being configured, cf. step 313 from FIG. 2N.

In further preferred specific embodiments, it is provided that only that processor core 102a, 102b, 102c, 102n to which a dedicated memory protection unit M1, M2, M3, M4 has been provided (cf. step 231 from FIG. 2D), configures this dedicated memory protection unit M1, M2, M3, M4 (step 231a from FIG. 2D).

In further preferred specific embodiments, it is provided that the method further includes, cf. FIG. 2P: checking 320 an integrity and/or authenticity of configuration data KD, which controls an operation of at least one memory protection unit, in particular, with the aid of at least one of the following elements: a) verification 322 of a program code useable for the configuration of the at least one memory protection unit, b) verification 324 of the configuration data, c) persistence 326 of a or of the program code useable for the configuration of the at least one memory protection unit, d) persistence 328 of the configuration data.

In further preferred specific embodiments, persistence 326, 328 may, for example, include a provision of the program code useable for the configuration of the at least one memory protection unit or of the configuration data in a read-only memory, for example, in a ROM or an OTP (one-time programmable memory).

In further specific embodiments, it is provided that the method further includes, cf. FIG. 2Q: at least temporary execution 330 of a secure boot method and/or at least temporary execution 332 of a method for manipulation detection during the runtime (RTMD, runtime manipulation detection), in particular, by at least one processor core of computing unit 100, 100a. Methods 300, 332 may, for example, include the comparison of an actually present memory content of at least one part of memory 1030, 1032 with a predefinable reference memory content, the comparison also being able to include, for example, a hash value formation and/or use of CMAC (cipher-based message authentication code) methods and/or use of signatures or signed hash values.

In further preferred specific embodiments, it is provided that the method further includes, cf. FIG. 2R: controlling 340 an access of an application program AP1, AP2 to at least one of the following elements as a function of at least one zone Z1, Z2: a) internal interface, in particular, software interface, of the computing unit, b) internal and/or external hardware interface of the computing unit, c) hardware security module and/or cryptography module for carrying out cryptographic functions, d) peripheral devices of the computing unit, in particular, special function registers of at least one peripheral device, e) internal interfaces of a target system for the computing unit, in particular, of a control unit, f) external interfaces of a target system for the computing unit, in particular, of a control unit, g) addressing elements for communication protocols, in particular, on at least one layer of the ISO/OSI layer model. Optional step 342 according to FIG. 2R indicates, for example, a (further) embodiment of the relevant application program in the zone to which it is assigned.

In further preferred specific embodiments, it is provided that the method further includes at least one of the following elements, cf. FIG. 2S: a) introducing 350 at least one additional, in particular not already existing, zone, b) shifting 352 functionalities from a first processor core 102a to at least one further processor core 102b of computing unit 100, 100a, c) executing 354 a communication between at least two zones using a working memory integrated, in particular, into the computing unit, d) defining 360, cf. FIG. 2T, at least one trustworthy zone and, optionally, monitoring 362 at least one further, in particular, non-trustworthy zone, by at least one application program assigned to the trustworthy zone.

Further preferred specific embodiments, aspects and advantages of the principle according to the specific embodiments are described below with reference to FIGS. 6 through 21, which—according to further preferred specific embodiments—are combinable individually per se or in combination with one another with at least one of the specific embodiments described above.

FIG. 6 schematically shows aspects of an interrupt service routine ISR1 according to further preferred specific embodiments, as they are executable, for example, at least temporarily by at least one processor core 102a, 102b, . . . of computing unit 100, 100a. Flash symbol IRQ in FIG. 6 symbolizes an occurring interrupt request, as it may be generated, for example, cyclically (for example, predefinably by timer component (timer)) and/or event-controlled (for example, arrival of a message at a communication interface). In further preferred specific embodiments, interrupt service routine ISR1 is subsequently carried out, which includes at least one of the following elements: e1) at least temporarily storing a context of the task or program interrupted by interrupt request IRQ, for example, on the stack memory (may, for example, be defined in a predefinable area of RAM 1030), e2) identifying a task to be subsequently carried out, e3) switching from an instantaneous operating mode, for example, supervisor mode, to another operating mode, for example, user mode, e4) restoring the task for the identified zone.

In further preferred specific embodiments, interrupt service routine ISR1 according to FIG. 6 may, for example, be used by operating system BS (FIG. 4), in particular, during an inter-core-zone-separation.

FIG. 7 schematically shows aspects of an interrupt service routine ISR2 according to further preferred specific embodiments, as it is executable, for example, at least temporarily by at least one processor core 102a, 102b, . . . of computing unit 100, 100a.

Flash symbol IRQ′ in FIG. 7 symbolizes an occurring interrupt request, as it may be generated, for example, cyclically (for example, predefinably by timer component (timer)) and/or event-controlled (for example, arrival of a message at a communication interface). In further preferred specific embodiments, interrupt service routine ISR2 is subsequently carried out, which includes at least one of the following elements: e1′) storing at least temporarily a context of the task or program interrupted by interrupt request IRQ′, for example, on the stack memory, optionally: e5) carrying out an evaluation, for example, of the stack memory (cf., for example, step 302 from FIG. 2K) and/or of the program counter (cf. for example, step 304 from FIG. 2K), e6) identifying a task to be subsequently carried out, e7) switching the context to an identified zone (for example, from preceding step e6), the identified zone being associated with the identified task to be subsequently carried out) (alternatively, the switch in further preferred specific embodiments may, for example, also take place in an address-based manner, for example, with the aid of CAN ID, VLAN ID, MAC address or the like), e8) switching from an instantaneous operating mode, for example, supervisor mode, to another operating mode, for example user mode, e9) restoring a context for the following task.

In further preferred specific embodiments, interrupt service routine ISR2 according to FIG. 7 may, for example, be used by supervisor SV (FIG. 5), in particular, during an intra-core-zone-separation.

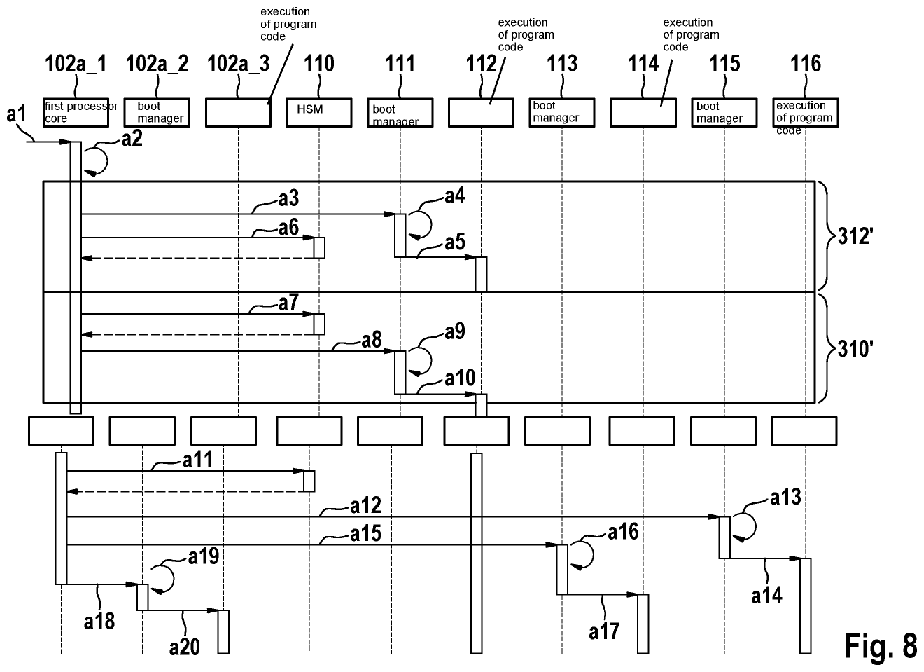

FIG. 8 schematically shows a flowchart according to further preferred specific embodiments, reference numeral 310′ identifying, for example, aspects of a cold start of computing unit 100, 100a, and reference numeral 312′ identifying, for example, aspects of a warm start of computing unit 100, 100a. In cold start 310′, for example, a test pattern for a verification of the content of RAM 1030 (FIG. 3) is not available. A test pattern for a verification of the content of RAM 1030 (FIG. 3) is, for example, available in warm start 312′.

In further preferred specific embodiments, a test pattern or pattern may be written into the volatile memory powered, in particular, in a power-down mode as part of a cold start to be run through at least once. Thus, due to the aforementioned power, the aforementioned test pattern or pattern is maintained in the volatile memory per se. This RAM pattern in further preferred specific embodiments is checked in at least one, in particular, in each, start cycle of a system state machine (state machine, which is useable in further preferred specific embodiments, for example, for controlling system states), and a cold start (for example, when the RAM pattern is not present) or a warm start (for example, when the RAM pattern is present) may be carried out, in particular, as a function of the existence of the test pattern.

Thus, in further preferred specific embodiments, an integrity and authenticity of the volatile memory powered in the power-down mode or its data and functionalities contained or situated therein (for example, processor core 102c and/or configuration data of the memory protection unit, in particular, for the first and/or second zone and/or a program code) as part of the preceding cold start necessarily to be run through at least once (secure boot and/or start from OTP memory—see above) is ensured.

Thus, in further preferred specific embodiments, an invalid manipulation of the data and functionalities situated in the volatile memory powered in the power-down mode and of the RAM pattern implies an at least temporary power interruption and thus an erasure of the volatile memory (RAM pattern, etc.) powered in the power-down mode. In further preferably specific embodiments, the system state machine would accordingly initiate, in particular, automatically, a cold start (secure boot and/or start from OTP—see above) as part of the start cycle due to the missing RAM pattern, with which the integrity and authenticity of the volatile memory powered in the power-down mode or its data and functionalities prior to its use or execution is ensured.

In further preferred specific embodiments, it is provided that with the existence of the test pattern, for example, within the scope of a warm start, selected time-critical SW instances are not checked prior to their execution, (i.e., for example, in particular, no secure boot), but, if necessary, only at the runtime after their execution. In this way, a startup time for time-critical SW instances during the warm start is advantageously accelerated. The integrity and authenticity during the warm start is thus advantageously ensured in further preferred specific embodiments implicitly by the availability of the test pattern (and thus the check during the previous cold start) even without an explicit check during the warm start. Non-time-critical components in further specific embodiments may also be checked during the warm start explicitly prior to their execution (for example, with the aid of a secure boot process).

Block 102a_1 symbolizes by way of example first processor core 102a of the computing unit (FIG. 3) as “root of trust,” i.e., comparable to a hardware security reference similar to a TPM (trusted platform module) or to a hardware security module (HSM), block 102a_2 represents a boot manager (system program, which controls a loading and/or execution of further system programs and/or application programs) associated with processor core 102a. Block 102a_3 represents an execution of program code associated with zone Z2 and processor core 102a. Block 110 represents a hardware security module. Block 111 represents a boot manager associated with processor core 102c. Block 112 represents an execution of program code associated with zones Z1, Z2 and processor core 102c (which, as described already multiple times and by way of example above, is assigned to both zones Z1, Z2). Block 113 represents a boot manager associated with processor core 102b. Block 114 represents an execution of program code associated with zone Z1 and with processor core 102b. Block 115 represents a boot manager associated with processor core 102n. Block 116 represents an execution of program code associated with zones Z1, Z2 and processor core 102n.

Arrow a1 symbolizes a boot process (power-up of computing unit 100a, for example, from a fully deactivated state). Arrow a2 symbolizes a configuration of at least one memory protection unit, in particular, of a central memory protection unit M5_1, M5_2, . . . , M5_8 or of one assigned to bus system 101 (FIG. 3).

Arrow a3 symbolizes a start of the boot manager for processor core 102c, cf. also block 111.

Arrow a4 symbolizes a configuration of at least one dedicated memory protection unit M3 (FIG. 3) for processor core 102c. Arrow a5 symbolizes the start of an execution 112 of program code by processor core 102c. Arrow a6 symbolizes an optional verification of processor core 102c, for example, in the form of an RTMD.

Arrow a7 also symbolizes an optional verification of processor core 102c in the context of a cold start 310′. In further preferred specific embodiments, optional verification a7 may be carried out with the aid of cryptographic methods, for example, based on CMACs and/or on signed hash values. Arrow a8 symbolizes a start of the boot manager for processor core 102c, similar to arrow a3, cf. also block 111. Arrow a9 symbolizes, in particular, similar to arrow a4, the configuration of the at least one dedicated memory protection unit M3 (FIG. 3) for processor core 102c. Arrow a10 symbolizes the start of an execution 112 of program code by processor core 102c, similar to arrow a5.

Arrow all symbolizes an optional verification of multiple, preferably of all, processor cores 102a, 102b, . . . , 102n. Arrow a12 symbolizes a start of the boot manager for processor core 102n, cf. also block 115. Arrow a13 symbolizes the configuration of at least one dedicated memory protection unit for processor core 102n. Arrow a14 symbolizes the start of an execution 116 of program code by processor core 102n.

Arrow a15 symbolizes a start of the boot manager for processor core 102b. Arrow a16 symbolizes the configuration of at least one dedicated memory protection unit for processor core 102b.

Arrow a17 symbolizes the start of an execution 114 of program code by processor core 102b.

Arrow a18 symbolizes a start of the boot manager for processor core 102a. Arrow a19 symbolizes the configuration of at least one dedicated memory protection unit for processor core 102a.

Arrow a20 symbolizes the start of an execution 102a_3 of program code by processor core 102a.

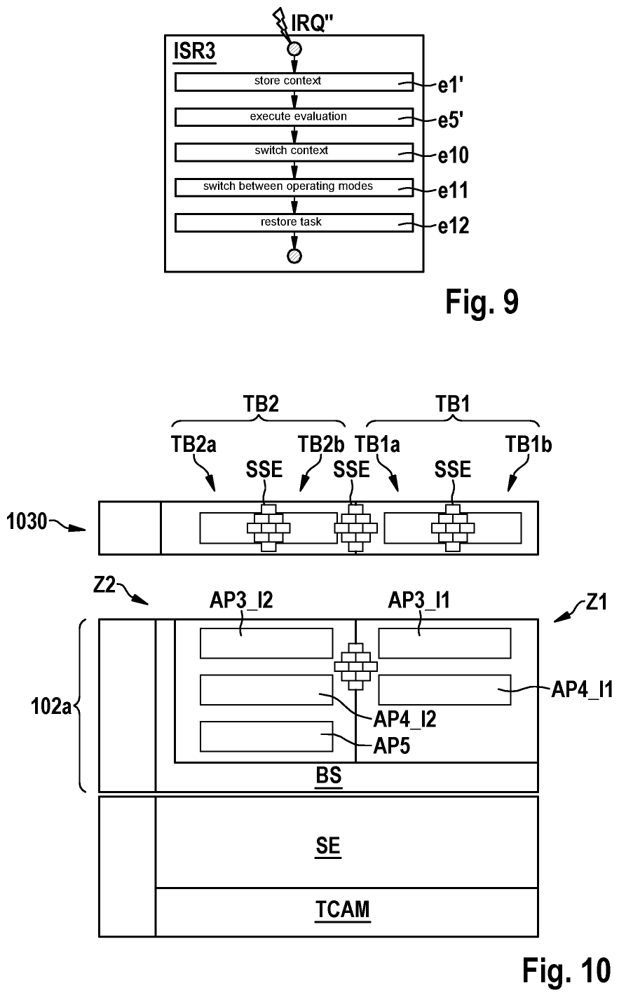

FIG. 9 schematically shows aspects of an interrupt service routine ISR3 according to further preferred specific embodiments, as they are executable, for example, at least temporarily by at least one processor core 102a, 102b, . . . , of computing unit 100, 110a. Flash symbol IRQ″ in FIG. 9 symbolizes an occurring interrupt request, as it may be generated, for example cyclically (for example, predefinably by timer component (timer)) and/or software-based (for example, called up by an application program). In further preferred specific embodiments, interrupt service routine ISR3 is subsequently carried out, which includes at least one of the following elements: e1′) at least temporarily storing a context of the task or program interrupted by interrupt request IRQ″, optionally: e5′) execution of an evaluation, for example, of the stack memory (cf. for example, step 302 from FIG. 2K) and/or of the program counter (cf. for example, 304 from FIG. 2K), e10) switching of the context to a next task (for example, as a function of a preferably static task list), e11) switching from an instantaneous operating mode, for example, supervisor mode, to another operating mode, for example, user mode, e12) restoring the task for the identified zone.

FIG. 10 schematically shows a processor core 102a according to further preferred specific embodiments, to which an operating system BS and/or a supervisor SV (similar to FIG. 5, not shown in FIG. 10) is assigned, and which itself is assigned to two zones Z1, Z2. Processor core 102a may, for example, be used for a network switch, for example, in order to send and/or to receive Ethernet data packets. Corresponding instances of application programs are identified with reference numeral AP3_I1 (receiving Ethernet packets, execution in zone Z1), AP3_I2 (receiving Ethernet packets, execution in zone Z2), AP4_I1 (sending Ethernet packets, execution in zone Z1), AP4_I2 (sending Ethernet packets, execution in zone Z2). One further application program, which executes, for example, management tasks for the network switch, runs only in second zone Z2 defined as trustworthy, but not in first zone Z1 defined as non-trustworthy. Processor core 102a is assigned a RAM 1030, which in further preferred specific embodiments may be divided, for example, similar to FIG. 5. Optionally, a switching engine (for example, switching network) is provided and/or a TCAM (ternary content-addressable memory) module.

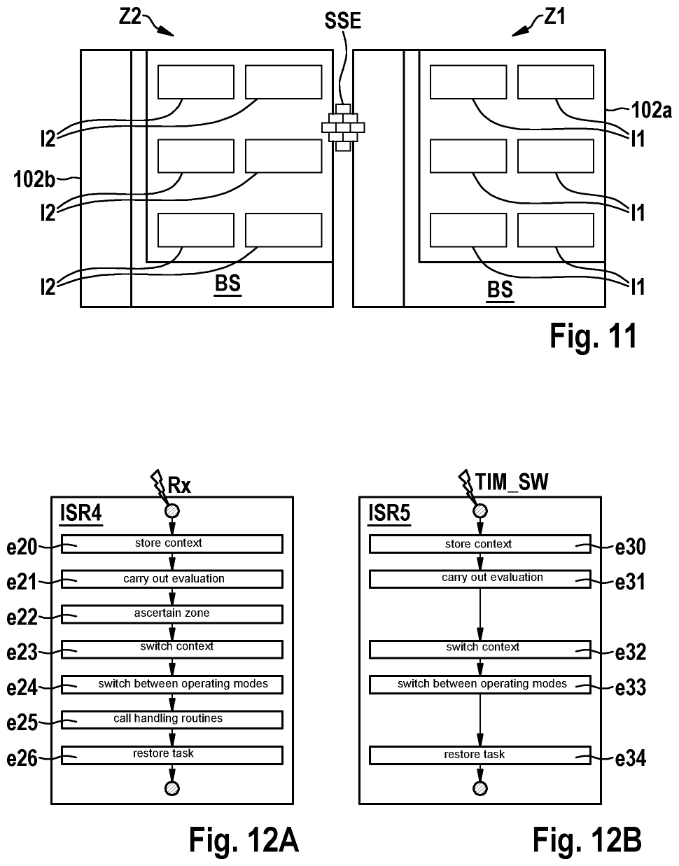

FIG. 11 schematically shows two processor cores 102a, 102b according to further preferred specific embodiments, first processor core 102a being assigned to a first zone Z1 and second processor core 102b being assigned to a second zone Z2. Both processor cores 102a, 102b are each assigned one operating system BS.

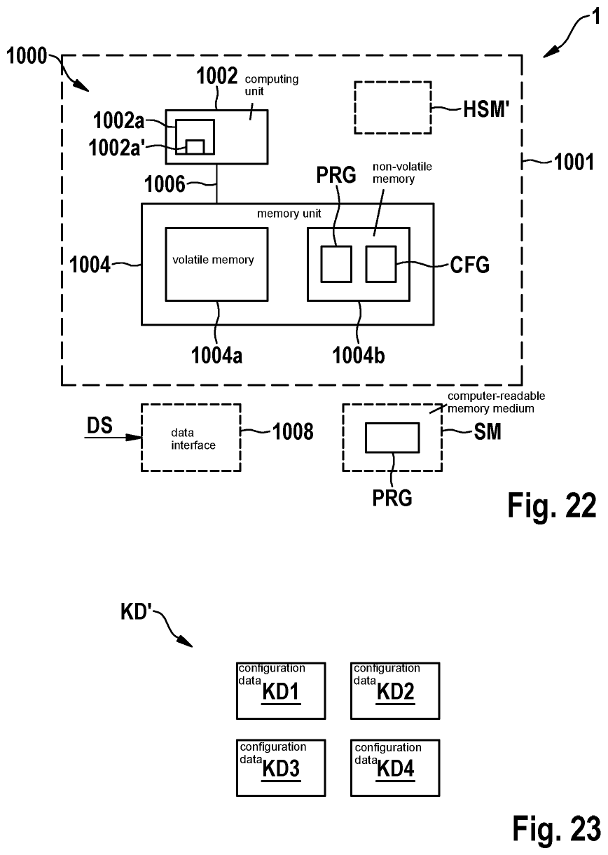

First instances of various application programs, which are identified in FIG. 11 for the sake of clarity together with reference numeral I1, are assigned to first zone Z1 and thus to first processor core 102a. In further preferred specific embodiments, the various application programs include, for example, at least one of the following elements: a) programs for executing an inspection of data packets, in particular, for deep packet inspection, DPI, b) programs for diagnosing, c) programs for executing updates, in particular, with the aid of FOTA (firmware over the air) technologies (for example with the aid of data interface 1008, FIG. 22), d) programs for attack detection and attack prevention (intrusion detection and prevention). In further preferred specific embodiments, two instances 12 of the application programs described above with reference to first zone Z1 are assigned to second processor core 102b and second zone Z2. At least one memory protection unit SSE according to further preferred specific embodiments is usable for controlling the read rights and/or write rights and/or execution rights of corresponding application programs or instances of the various zones. With the aid of the configuration described above by way of example with reference to FIG. 11, it is possible to efficiently provide a particularly secure system for inspecting data packets or for attack detection and attack prevention, for example, for electronic control units and/or for embedded systems and/or for IoT systems and the like, it being possible with the aid of the assignment of instances I1, I2 of the application programs to zones Z1, Z2 to particularly advantageously provide, for example, contexts in each case for the execution with different trust levels.

FIG. 12A schematically shows aspects of an interrupt service routine ISR4 according to further preferred specific embodiments, as they are executable, for example, at least temporarily by at least one processor core 102a, 102b, . . . of computing unit 100, 100a. Flash symbol Rx in FIG. 12A symbolizes an occurring interrupt request, as it may be generated, for example, in an event-controlled manner, in the present case, for example, upon receipt of a message, for example, of a CAN (controller area network) message. In further preferred specific embodiments, interrupt service routine ISR4 is subsequently carried out, which includes at least one of the following elements: e20) storing at least temporarily a context of the task interrupted by interrupt request Rx, in particular, of a send task (“Tx task”), for example, for sending out messages or programs, optionally: e21) carrying out an evaluation, for example, of the stack memory (cf., for example, step 302 from FIG. 2K) and/or of the program counter (cf., for example, step 304 from FIG. 2K), e22) ascertaining a zone, with which a received data frame (for example, the aforementioned CAN message) is associated, e23) switching the context to the zone ascertained in step e22, e24), switching from an instantaneous operating mode, for example, supervisor mode, to another operating mode, for example, user mode, e25) calling up a handling routine for the message reception (“receive (Rx) handler”), i.e., for example, of an application program or of a part of an application program, which processes the received message, e26) restoring the task (for example, send tasks) for the identified zone.

In further preferred specific embodiments, send tasks, i.e., tasks or application programs or parts of application programs for sending out messages, are planned (“scheduling”).

In further preferred specific embodiments, interrupt requests that characterize the reception of a message (“Rx IRQ,” receive interrupt request) are processed with a higher priority than other interrupt requests, which are triggered, for example, by timers and/or application programs or by software in general.

In further preferred specific embodiments, incoming interrupt requests are prioritized simultaneously or within a predefinable first time range, for example, as a function of the source of the interrupt request (incoming message, timer, software) and/or as a function of one or of multiple other or further criteria.

In further preferred specific embodiments, such a prioritization may be carried out, for example, by a control unit for interrupt requests (interrupt controller).

In further preferred specific embodiments, the switching of the context, cf., for example, step e23 of FIG. 12A, may take place exclusively in a predefinable operating mode, in particular, in the supervisor mode.

The aspects described by way of example above with reference to FIG. 12A may be utilized in further preferred specific embodiments, for example, to at least temporarily control the processing of incoming messages for a lightweight supervisor, in particular, for a CAN lightweight supervisor.

FIG. 12B schematically shows aspects of an interrupt service routine ISR5 according to further preferred specific embodiments, as they are executable, for example, at least temporarily by at least one processor core 102a, 102b, . . . of processor core 100, 100a. Flash symbol TIM_SW in FIG. 12B symbolizes an occurring interrupt request, as it may be generated, for example, by a timer or by an application program or by software in general. In further preferred specific embodiments, interrupt service routine ISR5 is subsequently executed, which includes at least one of the following elements: e30) at least temporarily storing a context of the task interrupted by interrupt request Rx, in particular of a send task (“Tx task”), for example, for sending out messages, or programs, optionally, e31) carrying out an evaluation, for example, of the stack memory (cf., for example, step 302 from FIG. 2K) and/or of the program counter (cf., for example, step 304 from FIG. 2K), e32) switching the context to a next send task (for example, according to an, in particular, static task list), e33) switching from an instantaneous operating mode, for example, supervisor mode, to another operating mode, for example, user mode, e34) restoring the task (for example, send task) for the identified zone.

The further aspects described above by way of example with reference to FIG. 12A apply correspondingly in further preferred specific embodiments to interrupt service routine ISR5 according to FIG. 12B.

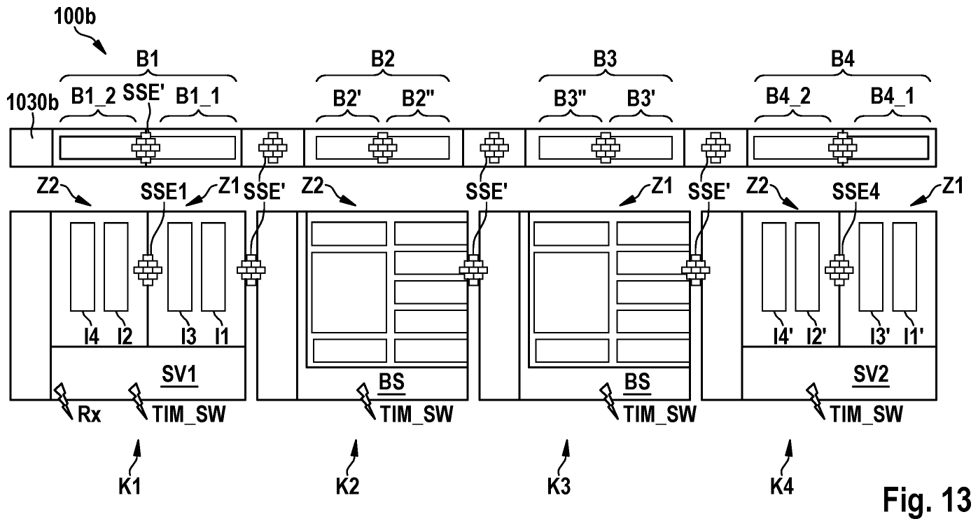

FIG. 13 schematically shows a simplified block diagram of aspects of a computing unit 100b according to further preferred specific embodiments. Computing unit 100b in the present case includes four processor cores K1, K2, K3, K4, the first processor core K1 of which is designed for processing communication messages, in particular, CAN messages. In further preferred specific embodiments, first processor core K1 according to FIG. 13 may thus also be referred to as a “CAN core.” The further processor cores K2, K3 are provided for executing (potentially different instances of) application programs and in further preferred specific embodiments may thus also be referred to as “application cores” K2, K3. Fourth processor core K4 according to FIG. 13 is designed for processing Ethernet communication messages and in further preferred specific embodiments may thus also be referred to as Ethernet core or ETH core K4. First processor core K1 is assigned a first supervisor SV1, in particular, a CAN lightweight supervisor, and further processor core K4 is assigned a second supervisor SV2, in particular, an ETH (Ethernet) lightweight supervisor.

In further preferred specific embodiments, first processor core K1 is assigned to two zones Z1, Z2. In further preferred specific embodiments, fourth processor core K4 is also assigned to two zones Z1, Z2.

In further preferred specific embodiments, first processor core K1 is assigned an application program for sending and/or receiving CAN messages, reference numeral I1 in FIG. 13 denoting a first instance of this application program, which first instance I1 is assigned to first zone Z1 and is designed to receive CAN messages. In contrast, reference numeral 12 denotes a second instance of this application program, which is assigned to second zone Z2 and is designed to receive CAN messages. Reference numerals I3, I4 denote corresponding instances for sending or receiving CAN messages, each of which is also assigned to one of the two zones Z1, Z2.

In further preferred specific embodiments, interrupt requests Rx, TIM_SW described by way of example above with reference to FIGS. 12A, 12B, may be processed by first processor core K1, for example, by executing a corresponding interrupt service routine ISR4 (FIG. 12A) or ISR5 (FIG. 12B).

In further preferred specific embodiments, fourth processor core K4 is assigned an application program for sending and/or receiving Ethernet messages, reference numeral I1′ in FIG. 13 denoting a first instance of this application program, which first instance I1′ is assigned to first zone Z1 and is designed to receive Ethernet messages. Reference numeral I2′, in contrast, denotes a second instance of this application program, which is assigned to second zone Z2 and is designed to receive Ethernet messages. Reference numerals I3′, I4′ denote corresponding instances for sending or receiving Ethernet messages, each of which is also assigned to one of the two zones Z1, Z2.

In further preferred specific embodiments, a separation of the two zones Z1, Z2 is achieved within processor cores K1, K4, each using at least one memory protection unit SSE1, SSE4.

As previously mentioned above, the two application cores K2, K3 are designed to execute application programs, which, or individual instances thereof, are indicated in FIG. 13 as rectangles within relevant application cores K2, K3 but, for reasons of clarity, are not identified in further detail. In further preferred specific embodiments, second processor core K2 is assigned to second zone Z2, and third processor core K3 is assigned to first zone Z1.

In further preferred specific embodiments, computing unit 100b includes a volatile memory, in particular, a working memory (RAN) 1030b which, similar to the representation according to FIG. 4, is divided into different areas, each of which is assigned to different processor cores K1, K2, K3, K4 or to their zones Z1, Z2.

For example, a first area B1 of working memory 1030b of computing unit 100b according to FIG. 13 is assigned to first processor core K1, one first subarea B1_1 being assigned to first zone Z1 and one second subarea B1_2 being assigned to second zone Z2. A similar division into corresponding areas or subareas B4, B4_1, B4_2 is possible in further preferred specific embodiments also for fourth processor core K4.

Further areas B2, B3 of working memory 1030b in further preferred specific embodiments are assignable, for example to application cores K2, K3. In further preferred specific embodiments, area B2, for example, is further divisible into a trustworthy area B2′ and into a non-trustworthy area B2″. The same may similarly apply in further preferred specific embodiments also for third application core K3, cf. reference numerals B3′, B3″.

In further preferred specific embodiments, one or multiple further memory protection units, which are identified collectively in FIG. 13 with reference sign SSE′, are provided in order to implement a respective separation according to preferred specific embodiments with respect, for example, to read rights and/or to write rights and/or to execution rights.

In further preferred specific embodiments, computing unit 100b according to FIG. 13 may, for example, provide the functionality of a gateway, i.e., a network coupling element, which is able, for example, to couple a CAN bus (cf. CAN core K1) with an Ethernet network (cf. ETH core K4). In further preferred specific embodiments, first processor core K1, for example, may adopt the function of a so-called high-speed routing engine for CAN messages, and/or fourth processor core K4 may adopt the function of a so-called high-speed engine for Ethernet messages.

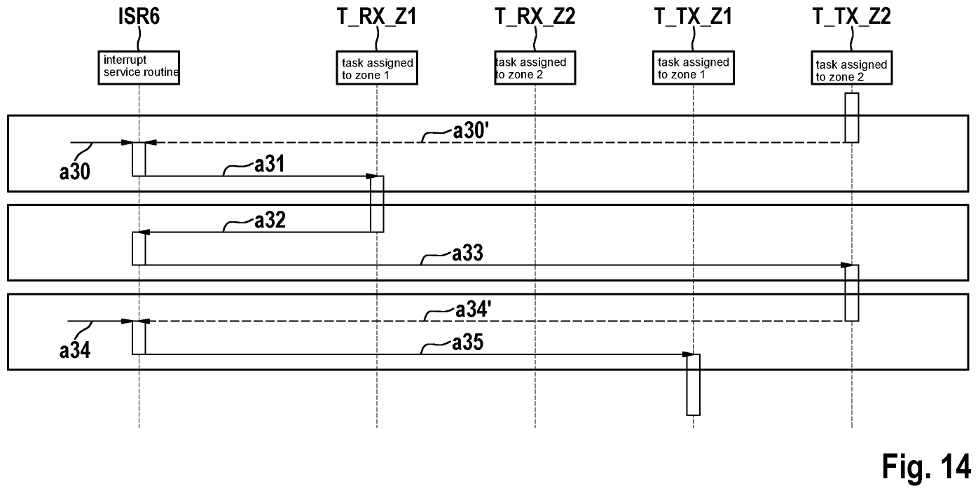

FIG. 14 schematically shows a flowchart according to further preferred specific embodiments, which illustrates by way of example the processing of interrupt requests, for example, upon receipt of messages, in particular, CAN messages.

Block ISR6 represents by way of example an interrupt service routine, which is executable, for example, in the case of at least one of the following interrupt requests: a) reception of a message “Rx,” b) signaling a timer, c) interrupt request “SW” generated with the aid of software. Block T_RX_Z1 represents by way of example, a task (for example, part or an instance of an application program), which is assigned to zone Z1 and is carried out upon receipt “Rx” of a message, similar to instance I1 of first processor core K1 of computing unit 100b according to FIG. 13. Block T_RX_Z2 represents by way of example a task, which is assigned to zone Z2 and is carried out upon receipt of a message, similar to instance 12 of first processor core K1 of computing unit 100b according to FIG. 13. Block T_TX_Z1 represents by way of example a task, which is assigned to zone Z1 and is carried out when sending a message, similar to instance I3 of first processor core K1 of computing unit 100b according to FIG. 13. Block T_TX_Z2 represents by way of example a task, which is assigned to zone Z2 and is carried out when sending a message, similar to instance I4 of first processor core K1 of computing unit 100b according to FIG. 13.

Arrow a30 represents an interrupt request, triggered by the reception of a (CAN) message, which interrupts, in particular, the processing of an instantaneously running task, cf. send task T_TX_Z2, cf. arrow a30′. As a result, receiver task T_RX_Z1 is called up in further preferred specific embodiments by interrupt service routine ISR6, cf. arrow a31. After receiver task T_RX_Z1 is carried out, it branches out, preferably with the aid of a software interrupt request (software interrupt) a32, in turn, to interrupt service routine ISR6, which then continues previously interrupted send task T_TX_Z2, cf. arrow a33. Upon occurrence a34 of an interrupt request (timer IRQ) generated by a timer, interrupt service routine ISR6 calls up send task T_TX_Z1, cf. arrow a35, which results in interruption a34′ of previously running send task T_TX_Z2.

From the diagram according to FIG. 14 and from the preceding descriptions, it is clearly apparent how different program parts (tasks) executable by a computing unit according to the specific embodiments, which are assigned according to the principle according to the specific embodiments to different zones Z1, Z2, . . . (more than two zones are also possible according to further preferred specific embodiments), may be executed or how their execution is controllable, for example, by an interrupt service routine ISR6, which may, for example, be a part of an operating system BS and/or of a supervisor SV.

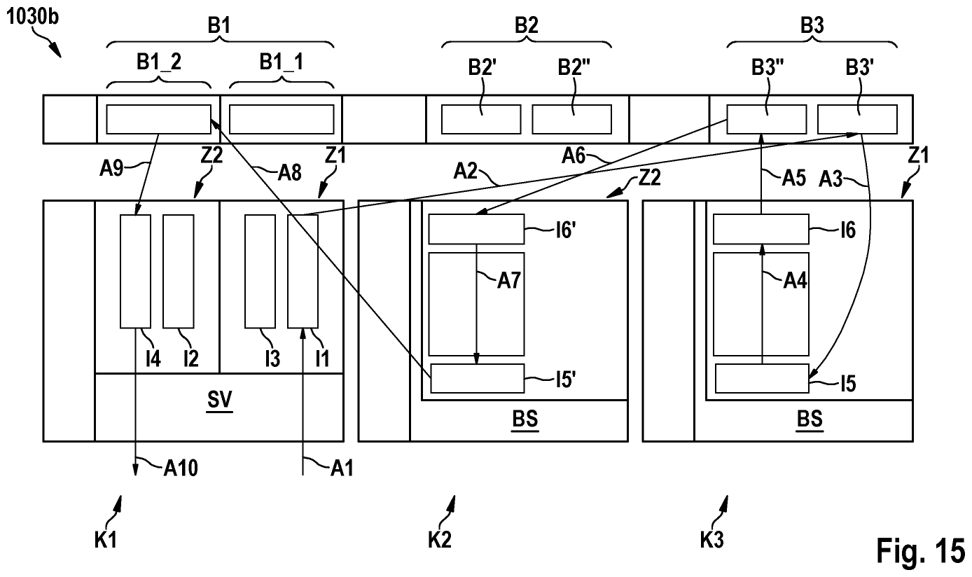

FIG. 15 schematically shows a simplified block diagram of aspects according to further preferred specific embodiments, in the present case one application being depicted by way of example, which involves an exemplary zone transition ZT, i.e., the transfer of data from one first zone according to the preferred specific embodiments into a second zone according to preferred specific embodiments.

First processor core K1 according to FIG. 15 corresponds in this case to CAN core K1 previously described above with reference to FIG. 13, and further processor cores K2, K3 from FIG. 15 correspond to application cores K2, K3 according to FIG. 13. The same similarly also applies to areas B1, B2, B3 of working memory 1030b or to its subareas.

Arrow A1 represents the reception of a CAN message, which triggers a processing by instance I1 of a corresponding application program of first processor core K1. Instance I1, which is assigned to first zone Z1, transfers data of the received CAN message or data derived therefrom via the working memory, cf. arrow A2, to an instance I5 of an application program for processing such data, which is assigned to first zone Z1, and is executable by third processor core K3, cf. arrow A3. Reference numeral I6 from FIG. 15 denotes an instance of an application program for inspecting data packets, in particular, deep packet inspection (DPI), which inspects the received data in greater detail and then writes them into subarea B3″ of working memory 1030B, cf. arrow A5. Further instance I6′ of the DPI application program, which is executed on second processor core K2 and which is assigned to second zone Z2, then reads the data from subarea B3″, which corresponds to the previously mentioned zone transition ZT, cf. arrow A6.

In further preferred specific embodiments, a, in particular, in-depth (in terms of a DPI), payload analysis is carried out, for example, by instance I6′ (“Z2-DPI proxy,” i.e., proxy assigned to second zone Z2 for carrying out DPI methods), instance I6 (“Z1-DPI proxy,” i.e., proxy assigned to first zone Z1 for carrying out DPI methods) being responsible for copying the data in B3″.

After an optional further processing of the data by second processor core K2, cf. arrow A7, the data or data derived therefrom are written by an instance I5′ into memory area B1_2 of working memory 1030b, cf. arrow A8, from which instance I4, which is designed, for example, to send CAN messages and which is assigned to second zone Z2, and which is executable by CAN core K1, removes the data and, for example, sends them out again to the CAN bus, cf. arrow A10.

The scenario described by way of example above with reference to FIG. 15 may be used for at least one of the following particular applications: a) diagnosis using CAN messages, b) DPI applied to CAN messages, c) formation of a proxy, for example, a proxy for a communication protocol and/or diagnostic protocol or the like, d) routing from, for example, a first CAN bus to, for example, a second CAN bus, in particular, including application programs (this enables, for example, a processing of the CAN messages to be routed, in particular, an analysis and/or modification).

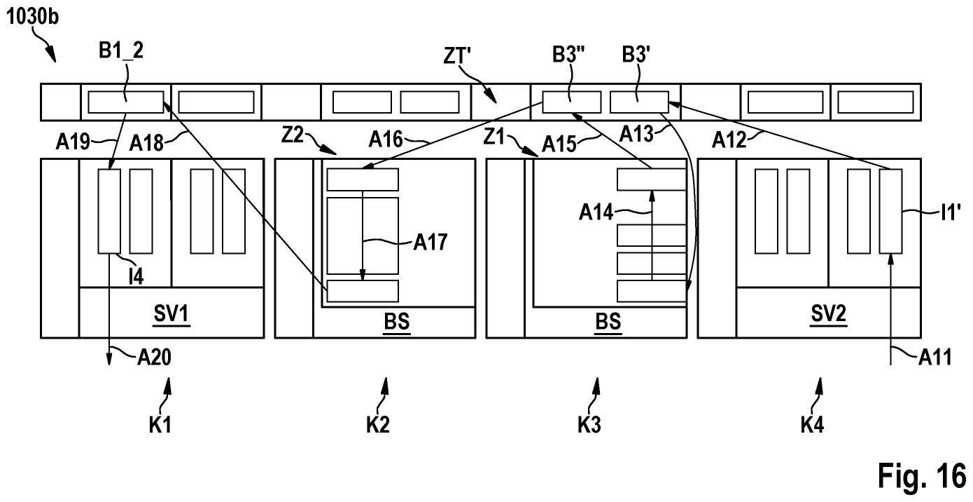

FIG. 16 schematically shows a simplified block diagram of aspects according to further preferred specific embodiments, in accordance with the representations of FIG. 13 and FIG. 15, in the present case, one particular application being depicted, for example, involving an exemplary zone transition ZT′, i.e., the transfer of data from a first zone according to the preferred specific embodiments into a second zone according to the preferred specific embodiments. In contrast to the scenario according to FIG. 15, zone transition ZT′ in the scenario according to FIG. 16 takes place starting from Ethernet core K4 to CAN core K1, according to arrows A11 through A20.

It is apparent from FIG. 16 that after reception A11 of the Ethernet message, corresponding data are stored in memory area B3′ (arrow A12), from where they are read in by application core K3 assigned to first zone Z1 (arrow A13), are processed (arrow A14) and the correspondingly processed data are then written into further memory area B3″ (arrow A15).

These data are then read in by application core K2 assigned to second zone Z2, cf. arrow A16, processed, cf. arrow A17, and written into further memory area B1_2, cf. arrow A18. The data from CAN core K1 are then read in (arrow A19) from further memory area B1_2, by instance I4 (part of an application program of sending out CAN messages) processed and sent out on the CAN bus (not shown), cf. arrow A20.

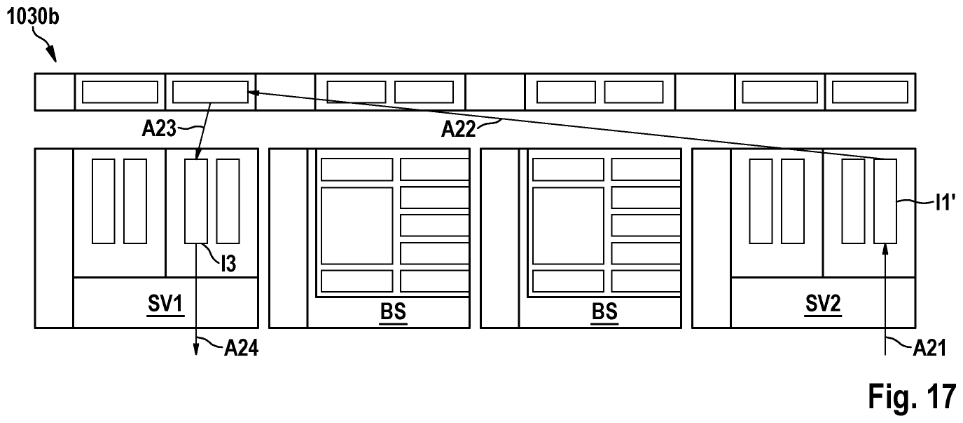

FIG. 17 shows by way of example a configuration comparable to FIG. 16, in which an incoming Ethernet message is received (A21) by processor core K4, buffered (A22) in working memory 1030b and read (A23) with the aid of an instance I3 of first processor core K1 and sent (A24) to a CAN bus.

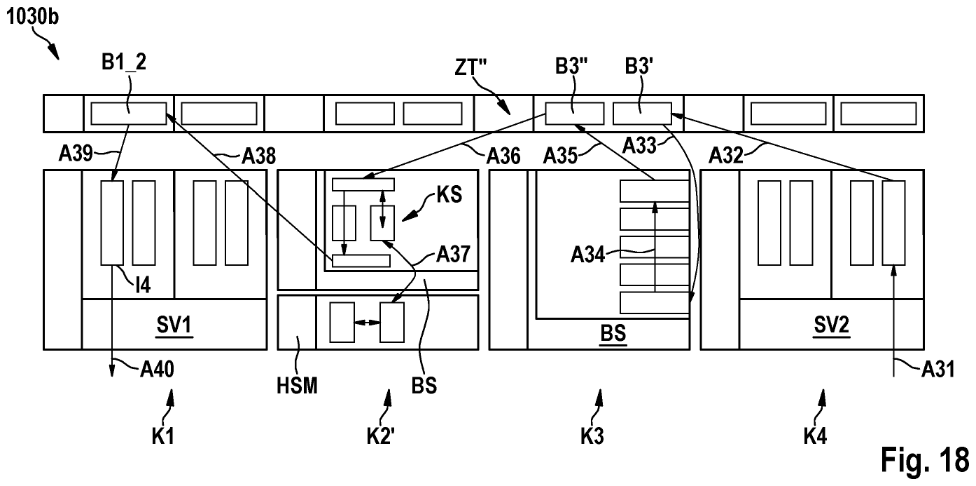

FIG. 18 schematically shows a simplified block diagram of aspects according to further preferred specific embodiments, in accordance with the representations of FIG. 13 and FIG. 15, in the present case, for example, a particular application being depicted, in which a hardware security module HSM is used. Hardware security module HSM in the present case is integrated, for example, into the computing unit (not identified in FIG. 18, cf. for example, reference numeral 100 from FIG. 1), which includes, among other things, also second processor core K2′, and is designed to carry out cryptographic functions. In further preferred specific embodiments, the cryptographic functions may include, for example, storing (secret) keys and/or forming hash values and or signatures and the like.

In further preferred specific embodiments, hardware security module HSM represents an autonomous (“on-chip”) module, which is situated preferably on the same semiconductor substrate or die (chip) as the computing unit. Hardware security module HSM preferably includes a separate processor core (not shown) and, if necessary, a separate memory, etc.

In further preferred specific embodiments, a crypto-stack KS is provided, which is useable for communicating between the processor cores of the computing unit and hardware security module HSM. In further preferred specific embodiments, this crypto-stack KS is implemented, in particular, for security reasons, solely on processor core K2′, since in the present case processor core K2′ represents by way of example the only processor core of the computing unit, which is assigned exclusively to trustworthy zone Z2. Thus, processor core K2′ in further preferred specific embodiments may be viewed as the “most secure core.” Arrows A31, A32, A33, A34, A35, A36 represent by way of example, the following steps: receiving (A31) an Ethernet message, storing (A32) the received message in area B3′, loading (A33) this message by an application program of third processor core K3, processing (A34) the loaded message by third processor core K3, writing (A35) the data obtained in the processing into memory area B3″, loading (A36) the written data from memory area B3″ via an application program, which is executable on second processor core K2.

In further preferred specific embodiments, second processor core K2 processes the loaded data, in particular, also using hardware security module HSM, cf. arrow A37. Processing A37 may include, for example, an encryption of data. Processed data A38 are then written (A38) in memory area B1_2. The data are subsequently loaded (A39) by the instance of CAN core K1 from memory area B1_2 and sent to the CAN bus.

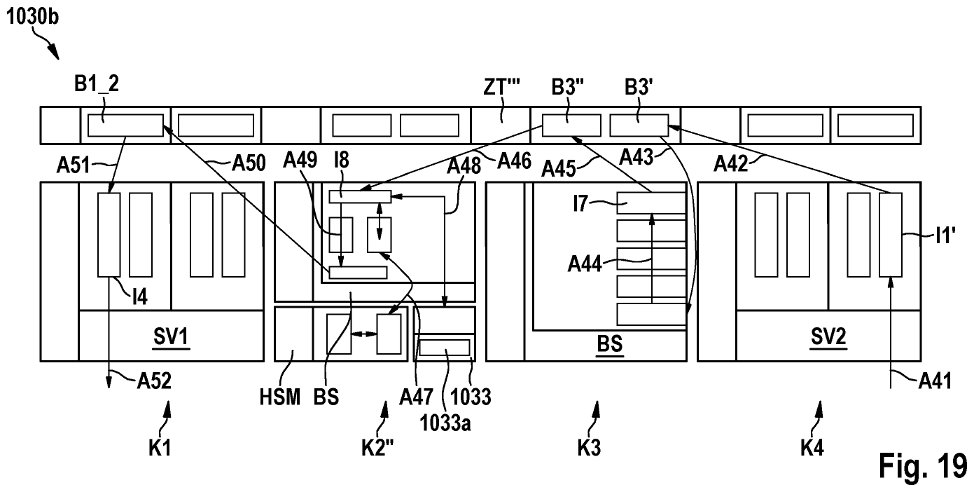

FIG. 19 schematically shows a simplified block diagram of aspects according to further preferred specific embodiments, in accordance with the representation of FIG. 18, in the present case, for example, a particular application being depicted, in which, for example a firmware update, in particular of the firmware over the air (FOTA) type, is executable. In preferred specific embodiments, for example, data may be received via an Ethernet connection, for example, with the aid of fourth processor core K4, cf. arrow A41. One instance I1′ of a receiving program writes the received data into a memory area B3″, cf. arrow A42. Instances of application programs on application processor core K3 load the data from memory area B3″ (A43) and process these (A44). A further instance 17, which is a first FOTA proxy 17, for example, extracts the data required for the FOTA process from the processed data and writes (A45) the extracted data into memory area B3″ viewed (in particular, from the perspective of second zone Z2) as non-trustworthy. One instance 18 of an application program which is, for example, a second FOTA proxy, and which is executable on processor core K2″, loads (arrow A46) the data from memory area B3″. Optionally, a cryptographic method may then be carried out on the loaded data by processor core K2″, for example, a CMAC formation, which advantageously utilizes hardware security module HSM, cf. arrow A47. In further preferred specific embodiments, processed data or CMAC values may be optionally stored in an external memory, cf. arrow A48. Such a memory is controlled in further preferred specific embodiments by FOTA proxy 18.

In further preferred specific embodiments, second zone Z2 includes only read rights but, in particular, no write rights and/or execution rights to memory area B3″. In further preferred specific embodiments, this may apply correspondingly, for example, also in the configurations described by way of example above with reference to FIGS. 4, 5.

In further preferred specific embodiments, complete memory images (“ECU image”) 1033a for at least one processor core or for the entire computing unit and/or for a corresponding control unit may, for example, also be stored at least temporarily in external memory 1033.

In further preferred specific embodiments, the content of data stored in external memory 1033 may, for example, be checked or validated by an application program executable by second processor core K2″ or by a corresponding instance thereof.

In further preferred specific embodiments, for example, after a successful validation of the data contained in external memory 1033, a corresponding memory image 1033a may be distributed to one or to multiple external devices (not shown), cf. arrows A49, A50, A51, A52, which involve, among other things, a, for example, block-wise copying of memory image 1033a from external memory 1033a into memory area B1_2 of working memory 1030b (A50) and from there to instance I4 (for example, CAN send task).

In further preferred specific embodiments, the validation may be preferably carried out based on digital signatures and/or signed hash values. In further preferred specific embodiments, for example, a signed hash value may exist for each ECU image. In further preferred specific embodiments, a signature verification may be carried out preferably via hardware security module HSM.

In further preferred specific embodiments, a preferably again block-wise check of a CMAC value and/or of another value, which enables a check of the integrity and/or authenticity of the relevant blocks, may also take place during the distribution or copying of memory image 1033a, for example, controlled by corresponding instances of application programs run, for example, on second processor core K2″, optionally supported by hardware security module HSM.

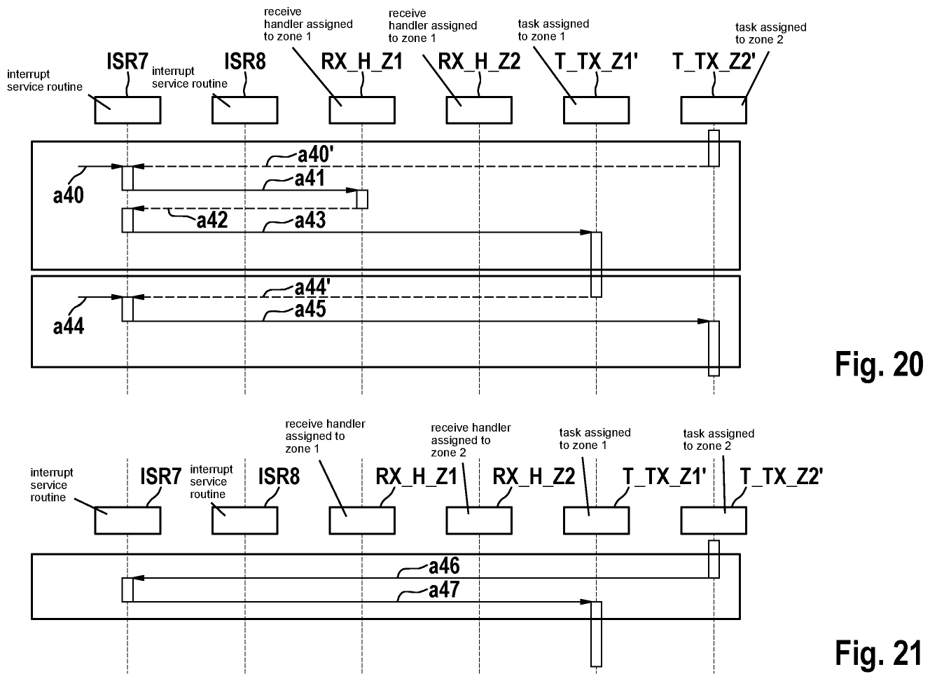

In further preferred specific embodiments, a formation and verification of, for example, CMAC values may function, in particular, as additional integrity protection and authenticity protection, for example, for signature verification. In further preferred specific embodiments, a single data packet or every single data packet from buffer B3″ may be provided with a CMAC value or a truncated CMAC value. This/these data packet(s) is or are verified in further preferred specific embodiments, for example, before a transfer into buffer B1_2, as a result of which, it is ensured, in particular, that only data packets that are integral and authentic enter into buffer B1_2. In further preferred specific embodiments, a buffer-wise CMAC generation and verification is optional. FIGS. 20, 21 schematically show flowcharts according to further preferred specific embodiments, which illustrate by way of example the processing of interrupt requests, for example, when messages, in particular CAN messages, are received.

Block ISR7 represents by way of example an interrupt service routine, which is executable, for example, in the case of interrupt requests that signal (“Rx ISR”) the reception of a message (“Rx”).

Block ISR8 represents by way of example an interrupt service routine, which is executable, for example, in the case of at least one of the following interrupt requests: a) signaling a timer, b) interrupt request (“SW ISR”) generated with the aid of software.

Block RX_H_Z1 represents by way of example a receive handler (for example, part or instance of an application program that controls the receipt of a message), which is assigned to zone Z1 and is executed upon receipt (“Rx”) of a message, similar to instance I1 of first processor core K1 of computing unit 100b according to FIG. 13.

Block RX_H_Z2 represents by way of example a receive handler (for example, part or instance of an application program that controls the receipt of a message), which is assigned to zone Z2 and is executed upon receipt (“Rx”) of a message, similar to instance 12 of first processor core K1 of computing unit 100b according to FIG. 13.

Block T_TX_Z1′ represents by way of example a task, which is assigned to zone Z1 and is executed when sending a message, similar to instance I3 of first processor core K1 of computing unit 100b according to FIG. 13. Block T_TX_Z2′ represents by way of example a task, which is assigned to zone Z2 and is executed when sending a message, similar to instance I4 of first processor core K1 of computing unit 100b according to FIG. 13.

Arrow a40 represents an interrupt request, triggered by the receipt of a (CAN) message, which interrupts, in particular, the processing of an instantaneously running task, cf. send task T_TX_Z2′, cf. arrow a40′. As a result, receive handler RX_H_Z1 is called up in further preferred specific embodiments by interrupt service routine ISR7, cf. arrow a41. After the execution of receive handler RX_H_Z1, the latter returns to interrupt service routine ISR7 (for example, preferably via an interrupt request generated with the aid of software), arrow a42.

According to the example according to FIG. 20, send task T_TX_Z1′ is then carried out, cf. arrow a43. In further preferred specific embodiments, this may include the particular advantage that as a result of task RX_H_Z1, the static configuration (for example, corresponding configuration data set) of the memory protection unit for first zone Z1 is already active, which applies preferably also to send task T_TX_Z1′. In this way, a switching of the relative static configuration of the memory protection unit before the execution of send task T_TX_Z1′ may, in particular, from a performance perspective, be dispensed with.

With the occurrence a44 of an interrupt request (timer IRQ) generated by a timer, interrupt servicer routine ISR7 calls up send task T_TX_Z2′, cf. arrow a45, which results in interruption a44′ of previously running send task T_TX_Z1′. A switch to the static configuration (for example, the corresponding configuration data set) of zone Z2 takes place preferably before the execution of send task T_TX_Z2′. The sequence then returns, for example, with the aid of a software interrupt a46, to interrupt service routine ISR7, whereupon send task T_TZ_Z1′ is continued, cf. arrow a47.

In further preferred specific embodiments, interrupt service routine ISR7 according to FIGS. 20, 21 may include, for example, a configuration comparable to or identical to configuration ISR4 according to FIG. 12A.

Further preferred specific embodiments, aspects and advantages of the principle according to the specific embodiments are described below, which—according to further preferred specific embodiments—are each combinable individually per se or in combination with one another with at least one of the above described specific embodiments.

In further preferred specific embodiments, a limitation of the access rights to memory 1030a, for example, according to FIGS. 4, 5 may be utilized as one measure for limiting an attack surface to the computing unit, which enables a zone-wise memory separation, for example, utilizing mechanisms of conventional memory protection units. In further preferred specific embodiments, a zone-wise memory separation in the memory forms cited by way of example below may particularly preferably take place: buffer (buffer memory), for example, in the form of a trustworthy buffer memory (trusted buffer (for example, in a shared RAM 1030)) and/or in the form of a non-trustworthy buffer memory (non-trusted buffer (for example, in shared RAM 1030)), stack (stack memory), data memory (for example, data flash, EEPROM, etc.), program memory (for example, program flash, ROM, etc.), SFRs (special function registers).

In further preferred specific embodiments, an exchange of data between various zones (“intra- and/or inter-zone data exchange”), may be implemented, for example, via a buffer situated in a shared RAM (divided working memory, cf. reference numeral 1030a from FIG. 4).

In further preferred specific embodiments, for example, at least one trusted buffer and non-trusted buffer each may be provided (depending on the particular application, buffers may optionally be omitted) per instance I1, I2, I3 (“proxy”) of an application program and per zone, cf. for example, subareas TB1a, TB1b from FIG. 4.

In further preferred specific embodiments, a data exchange within a zone or the intra-zone communication takes place, in particular, exclusively via trusted buffer TB2a (FIG. 4) of this zone.

In further preferred specific embodiments, a data exchange between zones or the inter-zone communication takes place preferably via non-trusted buffer TB1a situated in shared RAM 1030a. If in further preferred specific embodiments, for example, data are transferred from zone Z1 to zone Z2, then these are preferably initially copied by a Z1 proxy in associated Z1 non-trusted buffer, substantively verified by associated Z2 proxy regarding their validity and, in the case of valid or substantively correct trustworthy data, copied by Z2 proxy in the Z2 trusted buffer. The copying process after successful data verification by Z1 non-trusted buffer after Z2 trusted buffer is referred to in further preferred specific embodiments as zone transition. The verified, trustworthy data that is located in the Z2 trusted buffer may be correspondingly processed or forwarded within Z2 in further preferred specific embodiments, i.e., the data verification takes place in further preferred specific embodiments prior to the zone transition and, if necessary prior to data utilization.

One further measure for limiting the attack surface of the computing unit according to the specific embodiments is the limitation of the access rights to runtime according to further preferred specific embodiments, which may take place in further preferred specific embodiments, for example, under the control of a corresponding operating system BS or supervisor SV.

In further preferred specific embodiments, an AUTomotive Open System ARchitecture (AUTOSAR) BS, for example, which is reduced in further preferred specific embodiments to a minimum with respect to its complexity (for example, via configuration, etc.), may function as a basis for the lightweight embedded operating system BS, for example, according to FIG. 4 described by way of example above.

In further preferred specific embodiments, no invalid zone transition or invalid access of Z1 to Z2 memory or runtime may take place, even in the case of an escalation of privileges—for example, abuse of supervisor mode in lightweight embedded OS ISR emanating from a compromised processor core 102a (FIG. 3)—reasoning: static and drastically reduced functionality of the lightweight embedded BS, in further preferred specific embodiments, specifically sub-functionalities in the supervisor mode, thus allow no abuse of privileges in the supervisor mode.

In further preferred specific embodiments, an ISR (interrupt service routine) running in the supervisor mode is able to switch only between the static configuration data sets for the dedicated memory protection unit for the relevant processor core→identical static configuration data sets for supervisor mode and user mode of the processor core in further preferred specific embodiments allow access solely to memory and/or runtime, which are assigned to a relevant zone, for example, to first zone Z1.

In further preferred specific embodiments, an ISR running in the supervisor mode is unable to carry out any dynamic reconfiguration of the memory protection unit, this is, in particular, implicitly achievable by a static, integral and authentic configuration of the memory protection unit(s) during a start cycle, for example, during a cold start and/or during a warm start.

In further preferred specific embodiments, a task running in the user mode, which is assigned, for example, to first zone Z1, is not able to switch between static configuration data sets of memory protection unit dedicated for one particular processor core, because this switch in further preferred specific embodiments is possible only in the supervisor mode.

In further preferred specific embodiments, a task running in the user mode, which is assigned, for example to first zone Z1, is unable to carry out any dynamic reconfiguration of the memory protection unit(s), which in turn is advantageously implicitly achievable by a static, integral and authentic configuration of the memory protection unit(s) provided in further preferred specific embodiments during the start cycle, i.e., for example, during a cold start and/or during a warm start.

In further preferred specific embodiments, a supervisor SV, in particular a lightweight embedded supervisor, may have additional monitoring functionalities with respect to the operating system BS, in particular, to the lightweight embedded operating system. In the case of an intra-core-zone-separation (FIG. 5) on a dedicated processor core 102c, tasks PXY of two zones Z1 and Z2 are preferably carried out with different trust levels, in this case, preferably two different static configuration data sets for Z1 tasks (tasks or instances assigned to first zone Z1) and Z2 tasks being used in the user mode as well as, if necessary, a further static configuration data set for the supervisor mode, which controls, for example, the switch between the two static configuration data sets for the Z1 tasks and the Z2 tasks. In further preferred specific embodiments, a potentially remaining, unused static configuration data set for tasks in the user mode may be configured in such a way (for example, during a cold start and/or warm start), that the configuration data set, for example, prevents a general read access, write access and execution access to the complete memory, as a result of which the security is further increased.

In further preferred specific embodiments, it may be provided that the supervisor mode, in particular, in the context of an intra-core-zone-separation, controls a monitoring of a non-trustworthy zone Z1, cf., for example, the sequence according to FIG. 2M.

In further preferred specific embodiments, 3 or more zones Z1, Z2, Z3 (not shown), for example, may be provided, first zone Z1 being, for example, a highly trustworthy/highly-confidential zone, second zone Z2 being, for example, a trustworthy zone, and third zone Z3 being, for example, a non-trustworthy zone.

In further preferred specific embodiments, the computing unit may, for example, include a microcontroller or may be formed by a microcontroller including a corresponding number of processor cores.

According to studies by the inventors, the attack surface on computer units, for example, of control units and/or of embedded systems increases drastically in the context of highly-networked, modern vehicles, in particular due to the diverse external interfaces. Specifically, the risk of a so-called remote attack, i.e., a compromise, for example, via the Internet without physical access to the vehicle or to the computing unit exists. The principle according to the preferred specific embodiments may be advantageously used for the efficient mitigation of such remote attacks and/or of other attacks on a computing unit.

Further preferred specific embodiments relate to a device 1000 for carrying out the method according to the specific embodiments, cf. the schematic block diagram according to FIG. 22. Device 1000 includes a computing unit 1002 that includes at least one processor core 1002a, optionally at least one memory protection unit 1002a′ being able to be assigned to processor core 1002a.

Device 1000 further includes a memory unit 1004, which preferably has a volatile memory 1004a, for example, a working memory (RAN), and/or a non-volatile memory 1004b, for example, a flash EEPROM and/or a ROM and/or an OTP memory. A computer program PRG is preferably stored in ROM 1004b, which includes commands which, upon execution of program PRG by a computer 1002, prompt the computer to carry out the method according to the specific embodiments.

In further preferred specific embodiments, configuration data CFG for the operation of device 1000 are also stored in ROM 1004b. These configuration data CFG may also include, for example, one or multiple configuration data (sets) KD, KD′, KD1, KD2, KD3, KD4 for (the) at least one memory protection unit 1002a′.

In further preferred specific embodiments, it is provided that device 1000 includes at least one data bus 1006, which enables a data exchange between computing unit 1002 and memory unit 1004.

Further preferred specific embodiments relate to a computer-readable memory medium SM, including commands, in particular, in the form of a computer program PRG which, upon execution by a computer 1002, prompt the computer to carry out the method according to the specific embodiments.

Further preferred specific embodiments relate to a data carrier signal DS, which transfers computer program PRG according to the specific embodiments. Device 1000 may preferably include a, preferably bidirectional, data interface 1008 for receiving data carrier signal DS.

In further preferred specific embodiments, computing unit 1002 may also include a configuration according to computing unit 100, 100a, as described by way of example above with reference to, among others, FIGS. 1, 3. In further preferred specific embodiments, it is, in particular, also possible that the or a processor core 1002a of device 1000 according to FIG. 22 carries out at least temporarily at least some steps of the method according to the specific embodiments. In this regard, device 1000 may, for example, be seen as a possible target system for computing unit 100, 100a according to the specific embodiments.

In further preferred specific embodiments, device 1000 also includes a hardware security module HSM′ or cryptography module HSM′, for example, for carrying out cryptographic functions.

In further preferred specific embodiments, it is provided that device 1000 is designed as a microcontroller or microcontroller unit (MCU), in particular, as a single microcontroller (single MCU) or as a one-chip system (system-on-chip, SoC), in particular, as a single SoC.

In further preferred specific embodiments, it is provided that device 1000 includes a, in particular, shared semiconductor substrate 1001 (die), at least one of the following elements being situated on the, in particular, shared semiconductor substrate 1001: a) computing unit 1002 including at least one processor core, b) memory unit 1004, c) data bus 1006, d) the at least one memory protection unit 1002a, d) (optional) hardware security module HSM′.

The principle according to preferred specific embodiments thus advantageously enables a single MCU system 1 or single SoC system 1 to be provided, with simultaneous separation into two or more zones Z1, Z2.

In further preferred specific embodiments, an exchange of data between the various zones (“intra- and/or inter-zone data exchange”) may be implemented, for example, via a buffer situated in a shared RAM (divided working memory, cf. reference numeral 1030a from FIG. 4), the shared RAM being advantageously also situated on the same shared semiconductor substrate 1001 as computing unit 1002 or its processor core(s) 1002a and preferably further components 1006, HSM′, 1002a of single SoC system 1. This advantageously provides a high-performance (since MCU-internal or SoC-internal) and more secure (since MCU-internal or SoC-internal) communication channel between various zones Z1, Z2 which, according to further preferred specific embodiments, is also efficiently scalable (for example, multiple buffers in potentially further (additional) zones).

Preferred specific embodiments advantageously enable the “arrangement” of different zones Z1, Z2, for example, trustworthy (TZ) and non-trustworthy (NTZ) zones, and/or a data processing with respect to the data of different zones Z1, Z2 on the same, preferably single, MCU, or SoC system 1.

In further preferred specific embodiments, the method and/or device 100, 100a, 1000 according to the specific embodiments may be used in a control unit, for example, a control unit for a motor vehicle, in particular, a control unit for an internal combustion engine of a motor vehicle, for example, for at least one of the following particular applications: a) controlling an operation or operation state transition of the control unit, b) unblocking or blocking one or multiple functions of the control unit and/or of another component and/or, for example, of the motor vehicle, c) changing into an error mode and/or emergency operation, d) carrying out an error memory entry, e) signaling an operating state to an external unit and/or to a user, f) activating an actuator.

Further preferred specific embodiments relate to a use of the method according to the specific embodiments and/or of device 100, 100a, 1000 according to the specific embodiments and/or of computer program PRG according to the specific embodiments, for checking at least one subarea of memory unit 1030, 1032, 1004 for changes or manipulations, in particular, prior to or during or after a change of the memory unit, and/or of computing unit 100, 100a, 1002 accessing the memory unit, from a first operating state to a second operating state, and for controlling an operation, for example, of a control unit of an internal combustion engine of a motor vehicle as a function of the check. Further preferred specific embodiments, cf. FIG. 2U relate to a use of the method according to the specific embodiments and/or of the device according to the specific embodiments and/or of the computer program according to the specific embodiments for at least one of the following elements: a) providing 370 trust boundaries in computing unit 100, 100a (FIG. 1), in particular, also within a processor core 102c of the computing unit, b) reducing 371 (FIG. 2U) an attack surface for attacks on the computing unit and/or on one of its components, c) limiting 372 access rights to memory 1030, 1032, d) limiting 373 access rights to peripherals 1034 (FIG. 3), e) limiting 374 (FIG. 2U) access rights to computing resources (for example, characterizable by computing time, specification of a processor core), e) minimizing 375 an influence of a corrupt component, f) operating 376 a control unit, in particular, for a vehicle, in particular, for a motor vehicle, g) operating 377 an embedded system, in particular, an Internet-of-Things (IoT) system, h) operating 378 an application-specific integrated circuit, ASIC.

1-33. (canceled)

34. A method for operating a computing unit including at least one processor core, for an embedded system and/or for a control unit, the method comprising the following steps:
assigning each of one or multiple application programs executable by the computing unit to one of at least two zones, each zone of the zones characterizing resources of the computing unit, which are usable for an execution of the one or more application program assigned to the zone; and
executing at least one of the application programs as a function of the zone to which the at least one of the application programs is assigned.

35. The method as recited in claim 35, wherein the embedded system and/or the control unit is in a motor vehicle.

36. The method as recited in claim 34, wherein the computing unit includes multiple processor cores, and the method further comprising: a) assigning at least one of the processor cores to exactly one of the zones, and/or b) assigning at least one processor core to more than one of the zones.

37. The method as recited in claim 34, further comprising:
controlling, as a function of at least one of the zones, at least one of the following elements: a) read rights to memory assigned to the computing unit, b) write rights to memory assigned to the computing unit, c) execution rights to memory assigned to the computing unit.

38. The method as recited in claim 37, further comprising: using at least temporarily at least one memory protection unit for controlling the read rights and/or the write rights and/or the execution rights.

39. The method as recited in claim 36, further comprising: providing at least one dedicated memory protection unit for each of the processor cores.

40. The method as recited in claim 36, wherein at least one of the processor cores assumes at least temporarily a first operating mode, the at least one of the processor cores, in the first operating mode, predefining and/or writing configuration data, which control an operation of at least one memory protection unit, the at least one processor core assuming at least temporarily a second operating mode, in which it is unable to write and/or to change the configuration data for the at least one memory protection unit.

41. The method as recited in claim 40, wherein the at least one processor core assumes the first operating mode in an event-controlled manner, as a function of at least one interrupt request.

42. The method as recited in claim 40, further comprising: providing multiple sets of configuration data for the at least one memory protection unit, at least one first set of the multiple sets of configuration data being assigned to a first zone of the at least two zones and at least one second set of the multiple sets of configuration data being assigned to a second zone of the at least two zones.

43. The method as recited in claim 34, further comprising:
providing one first instance of an application program of the one or more application programs and one second instance of the application program;
assigning the first instance of the application program to a first zone of at least two zones; and
assigning the second instance of the application program to a second zone of the at least two zones.

44. The method as recited in claim 34, further comprising:
separating areas of a memory assigned to the computing unit as a function of the at least two zones, the memory assigned to the computing unit including at least one of the following elements: a) buffer memory, in particular, in the form of a working memory, b) stack memory, c) data memory, d) program memory, e) register memory;
wherein at least one memory protection unit is used for the separation.

45. The method as recited in claim 34, further comprising:
exchanging first data between various zones of the at least two zones via a buffer memory, the exchanging of the first data between a first zone of the at least two zones and a second zone of the at least two zones including the following steps:
copying the first data into a first buffer memory area of the buffer memory assigned to the first zone,
checking the copied first data, and
as a function of the check, copying the first data from the first buffer memory area assigned to the first zone into a second buffer memory area of the buffer memory assigned to the second zone.

46. The method as recited in claim 34, further comprising:
separating computing time resources for different application programs and/or for instances of application programs as a function of the at least two zones.

47. The method as recited in claim 36, further comprising:
a) assigning a respective operating system of an embedded system to each of the processor cores of the computing unit, and using the respective operating system for assigning computing time resources for different application programs and/or for instances of application programs; and/or
b) assigning a respective supervision of an embedded system of each of the processor cores of the computing unit, and using the respective supervisor for assigning computing time resources for different application programs and/or instances of application programs.

48. The method as recited in claim 47, wherein the respective operating system and/or the respective supervisor carries out an assignment of computing time resources only for predefined tasks using a static task list.

49. The method as recited in claim 47, wherein the respective operating system and/or the respective supervisor carries out an assignment of computing time resources as a function of a) periodically repeated interrupt requests and/or b) event-controlled interrupt requests; wherein tasks are activated from at least one interrupt service routine.

50. The method as recited in claim 34, wherein upon entry into an interrupt service routine, configuration data for at least one memory protection unit are changed in a hardware-controlled manner.

51. The method as recited in claim 47, further comprising:
monitoring, using the respective operating system and/or the respective supervisor, at least one of the following elements for a potential compromise: a) first zone of the at least two zone, b) an application program assigned to the first zone, c) an instance of an application program assigned to the first zone,
wherein the monitoring includes:
evaluating a stack memory and/or evaluating a program counter, the evaluation of the stack memory and/or the evaluation of the program counter taking place prior to an activation of the application program and/or of the instance of the application program.

52. The method as recited in claim 51, further comprising:
initiating an error response when the monitoring suggests a potential compromise, the error response including at least one of the following elements: a) transferring the first zone and/or the processor core assigned to the first zone into a secure state by deactivating the processor core assigned to the first zone and/or by resetting the processor core assigned to the first zone and/or transferring into an error mode, and/or b) generating an error entry, and/or c) forwarding the error entry to an intrusion detection system.

53. The method as recited in claim 34, wherein the computing unit executes at least temporarily a cold start, wherein during the cold start data and/or program code are loaded from a non-volatile memory, and the computing unit executes at least temporarily a warm start, wherein during the warm start data and/or program code being loaded from an at least temporarily energized volatile memory, and wherein during the cold start, at least one memory protection unit is configured, and/or during the warm start, the at least one memory protection unit is being configured.

54. The method as recited in claim 39, wherein only that processor core to which a dedicated memory protection unit has been provided, configures the dedicated memory protection unit.

55. The method as recited in claim 34, further comprising:
checking an integrity and/or authenticity of configuration data, which control an operation of at least one memory protection unit, using at least one of the following elements: a) verification of a program code usable for the configuration of the at least one memory protection unit, b) verification of the configuration data, c) persistence of the program code usable for the configuration of the at least one memory protection unit, d) persistence of the configuration data.

56. The method as recited in claim 36, further comprising:
executing, by at least one of the processor cores, at least temporarily a secure boot method and/or executing at least temporarily a method for manipulation detection during runtime.

57. The method as recited in claim 34, further comprising:
controlling an access of an application program to at least one of the following elements as a function of at least one zone of the at least two zones: a) a software interface of the computing unit, b) an internal and/or external hardware interface of the computing unit, c) a hardware security module (HSM) and/or cryptography module for carrying out cryptographic functions, d) peripheral devices of the computing unit including special function registers of at least one peripheral device, e) internal interfaces of a target system for the computing unit, f) external interfaces of a target system for the computing unit, g) addressing elements for communication protocols on at least one layer of an ISO/OSI layer model.

58. The method as recited in claim 36, further comprising a) introducing at least one additional not previously existing zone, and/or b) shifting functionalities from one first processor core of the processor cores to at least one further processor core of the processor cores of the computing unit, c) carrying out a communication between at least two zones of the at least two zones using a working memory integrated in the computing unit, d) defining at least one trustworthy zone and monitoring at least one further non-trustworthy zone via at least one application program assigned to the trustworthy zone.

59. A device configured to operate a computing unit including at least one processor core, for an embedded system and/or for a control unit, the device configured to:
assign each of one or multiple application programs executable by the computing unit to one of at least two zones, each zone of the zones characterizing resources of the computing unit, which are usable for an execution of the one or more application program assigned to the zone; and
execute at least one of the application programs as a function of the zone to which the at least one of the application programs is assigned.

60. The device as recited in claim 59, comprising at least one of the following elements: a) a computing unit including at least one processor core, b) a memory unit, c) a data bus, d) a memory protection unit, d) a hardware security module.

61. The device as recited in claim 59, wherein the device is a single microcontroller or a single one-chip system.

62. The device as recited in claim 60, wherein the device includes a shared semiconductor substrate, at least one of the following elements being situated on the shared semiconductor substrate: a) the computing unit including the at least one processor core, b) the memory unit, c) the data bus, d) the memory protection unit, d) the hardware security module.

63. A microcontroller system or a one-chip system configured to operate a computing unit including at least one processor core, for an embedded system and/or for a control unit, the microcontroller system or the one-chip system configured to:
assign each of one or multiple application programs executable by the computing unit to one of at least two zones, each zone of the zones characterizing resources of the computing unit, which are usable for an execution of the one or more application program assigned to the zone; and
execute at least one of the application programs as a function of the zone to which the at least one of the application programs is assigned.

64. A non-transitory computer-readable memory medium on which are stored commands for operating a computing unit including at least one processor core, for an embedded system and/or for a control unit, the commands, when executed by a computer, causing the computer to perform the following steps:
assigning each of one or multiple application programs executable by the computing unit to one of at least two zones, each zone of the zones characterizing resources of the computing unit, which are usable for an execution of the one or more application program assigned to the zone; and
executing at least one of the application programs as a function of the zone to which the at least one of the application programs is assigned.

65. The method as recited in claim 34, wherein the method is used or at least one of the following elements: a) providing trust boundaries in the computing unit, b) reducing an attack surface for attacks on the computing unit and/or on one of its components, c) limiting access rights to memories, d) limiting access rights to peripherals, e) limiting access rights to computing resources, e) minimizing an influence of a corrupted component, f) operating a control unit for a motor vehicle, g) operating an embedded system, the embedded system including an Internet-of-Things (IoT) system, h) operating an application-specific integrated circuit (ASIC), i) detecting a corrupted zone, j) initiating an error response in the event of a detected compromise.
